(19) United States
(12) Patent Application Publication
(10) Pub. No.: US 2015/0269635 A1
(43) Pub. Date: Sep. 24, 2015

(54) TRAFFIC SCHOOL MANAGEMENT SYSTEM AND PROCESS

(71) Applicant: Regis Registration Systems, LLC, Tucson, AZ (US)

(72) Inventor: Branson M. Smith, Tucson, AZ (US)

(73) Assignee: Regis Registration Systems, LLC, Tucson, AZ (US)

(21) Appl. No.: 14/223,565

(22) Filed: Mar. 24, 2014

(51) Int. Cl. G06Q 30/02; G06Q 50/20

(52) U.S. Cl. CPC G06Q 30/0276; G06Q 30/0261; G06Q 50/2053

(57) ABSTRACT

School management systems and methods are disclosed that may be used to handle student registration and day-to-day operations for businesses that offer specialized training or educational services. As an example, the invention may be used by traffic schools that offer classes as part of a defensive driving school, court ordered school, traffic survival school, student driver program, insurance discount program, corporate program or municipality program. The system preferably includes a master website that may be used to create a school administration website dedicated to a traffic school. The master website and/or the school administration website may create a public website. The master website may create additional dedicated administration websites for additional traffic schools. The traffic school may use the school administration website to create, modify and/or cancel classes offered on the traffic school's public website and students may use the public website to register for the classes.

### FIELD OF THE INVENTION

The present invention generally relates to the field of student online registration and educational institutes online administration, such as for traffic schools.

### SUMMARY OF THE INVENTION

The present invention provides systems and processes for handling online student registration and online day-to-day operations for businesses that offer specialized training or educational services. As a specific example, the present invention may be used by one or more traffic schools.

The system may include a public website for a traffic school to offer a plurality of classes. The public website may allow a plurality of students to register for one or more classes in the plurality of classes. The system may also include a school administration website, accessible by the traffic school, but not accessible by the plurality of students. The school administration website may be configured to create, modify and cancel one or more classes in the plurality of classes offered on the public website.

In another embodiment, the system may also include a master website configured to set up one or more traffic school, where each traffic school has a dedicated public website and a dedicated school administration website. The traffic school may offer one or more classes in a defensive driving school, a court ordered school, a traffic survival school, a student driver program, an insurance discount program, a corporate program or a municipality program.

In another embodiment, a method of the invention may be practiced by a master website creating a public website. The public website is preferably accessible over the Internet by a plurality of students and a student driving school. The master website may also create a school administration website. The school administration website may be accessed by the traffic school, but not by the plurality of students. In preferred embodiments, the public website and school administration website are dedicated to a single traffic school. The school administration website may be configured for the traffic school to modify a text, colors, an image, business rules, offerings and a class and/or a pricing for the class on the public website without the need of a programmer.

In another embodiment, the master website may create a plurality of public websites and a plurality of school administration websites for a plurality of traffic schools. Each public website in the plurality of public websites and each school administration websites in the plurality of school administration websites are preferably dedicated to one, and only one, traffic school.

In another embodiment, the public website lists one, and only one, most efficient and available instructor for each of a plurality of start time slots for a behind-the-wheel driving class to a student accessing the public website. The most efficient instructor may be determined, as a non-limiting example, based on a priority determined by the school that involves service areas, associated zones with associated zip codes that identify the most efficient instructor to service a student based on the student's zip code.

In another embodiment, the public website may display an active calendar. The active calendar may display business information in a unique manner such as to provide meaning to the display of classes that would not otherwise be observable without the user taking some type of action. Additionally, the active calendar provides integrated business management functionality that is not a part of a calendar function.

In another embodiment, the school administration website is designed, based on input from the student driving school, to combine a plurality of classes from the same or differing environments into a package offering for a single price in a simple, efficient and effective process. The package and the single price may appear in real-time on the public website.

In another embodiment, the school administration website may be configured, based on input from the student driving school, to extend a class that is expiring without having to reenter data associated with the expiring class except for future class dates.

In another embodiment, a court date for a student, in the plurality of students, may be extended via the public website or the school administration website.

In another embodiment, a plurality of classes offered by the student driving school may be limited based by either a city, a date range or a day of the week and/or sorted based on distance from the student's location, by city, date and time of class, location of the class and language.

In another embodiment, a school administration website may receive a geographical location from a traffic school. The traffic school may offer a student driver program in the geographical location. The school administration website may break the geographical location into a plurality of matrix zones and assign each instructor, in a plurality of instructors, to a matrix zone, in the plurality of matrix zones. The school administration website may determine a matrix zone or a zip code for a student accessing a public website dedicated to the traffic school. The school administration website may determine for each start time slot, in a plurality of start time slots, on the public website one, and only one, instructor that is available and most efficient. The most efficient instructor for each start time slot may be determined based on a matrix zone or zip code assigned to the instructor and the matrix zone or zip code determined for the student. The public website displaying the one, and only one, instructor for each start time slot in a plurality of start time slots to the student to select for a behind-the-wheel driving class.

In another embodiment, a zip code or zip codes may be associated with a zone. Each zone may be associated with one of more service areas for each instructor. In a preferred embodiment each zone is associated with one of five service areas for each instructor. Services areas and instructors may be associated with a specific location. A location may be any geographical area identified by the school such as, as non-limiting examples, Metro Phoenix, Central Phoenix, Tempe, East Valley, etc. . . . . A school may have an unlimited number of locations (across the United States as an example). A zip code is preferably not used in more than one zone. A zone may be a “matrix” zone or an “additional” zone. A zone is preferably only used in one location. An instructor is preferably only used in one location.

In another embodiment, the public website may receive a selection from the student for a selected instructor at a selected start time slot. The selected instructor may be notified of the selection by the student.

In another embodiment, an acceptance or a rejection to the creation of a class may be received from the selected instructor. If the selected instructor accepted the created class, the class may be displayed on the public website. Where the student travels to the class a plurality of classes and all instructors may be displayed on the public website. Where the instructor picks up the student, only the most efficient instructor for a given start time in a given zone may be displayed on the public website.

In another embodiment, a zip code is assigned to one, and only one, matrix or additional zone in the plurality of matrix and additional zones.

In another embodiment, a second geographical location is received from the traffic school.

In another embodiment, the selected instructor may be notified either by email, text message or phone call, based on the preference of the selected instructor.

In another embodiment, a school administrative system may allow the creation of classes in multiple environments in such a manner as to allow the most versatility in class creation, using the most efficient class creation process that offers a full-proof class creation that ensure only valid classes may be created.

In another embodiment, a school administrative website may allow the ability for the school to identify and change instructors with respect to classes for any reason in a simple, efficient and effective process.

In another embodiment, a school administrative website may allow the ability for the school to identify and change vehicles with respect to classes for any reason in a simple, efficient and effective process.

In another embodiment, a school administrative website may allow for the school to break up a package offering that was created for marketing, sales and ease or registration/purchasing purposes into individual classes within the Student Record.

In another embodiment, the student may be automatically notified by text message, email and/or phone call, based on the preference expressed by the student and the time frame identified by the school.

In another embodiment, a school administrative website may allow for the school to “close out” a class once it has been taught and record, process and update relevant student information in the Student Record.

The above features and advantages of the present invention will be better understood from the following detailed description taken in conjunction with the accompanying drawings.

### BRIEF DESCRIPTION OF THE DRAWINGS

FIG. 1 is a block diagram of an example embodiment of a system that may be used to practice the present invention.

FIG. 2 illustrates a flow diagram of an example method of practicing the invention

FIG. 3 illustrates a flow diagram of an example method of practicing the invention.

FIGS. 4-19 represent non-limiting examples of screen shots of a possible embodiment for a zone scheduling feature.

FIGS. 20-21 represent non-limiting examples of screen shots of a possible embodiment for an active calendar feature.

FIGS. 22-29 represent non-limiting examples of screen shots of a possible embodiment for a class room package creation feature.

FIGS. 30-31 represent non-limiting examples of screen shots of a possible embodiment for a class extension feature.

FIGS. 32-37 represent non-limiting examples of screen shots of a possible embodiment for a multifunctional class schedules presentation/selection feature.

FIGS. 38-39 represent non-limiting examples of screen shots of a possible embodiment for a factored class creation feature.

FIGS. 40-42 represent non-limiting examples of screen shots of a possible embodiment for a change instructor feature.

FIGS. 43-44 represent non-limiting examples of screen shots of a possible embodiment for a change vehicle feature.

FIG. 45 represents a non-limiting example of a screen shots of a possible embodiment for an active class completion feature.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

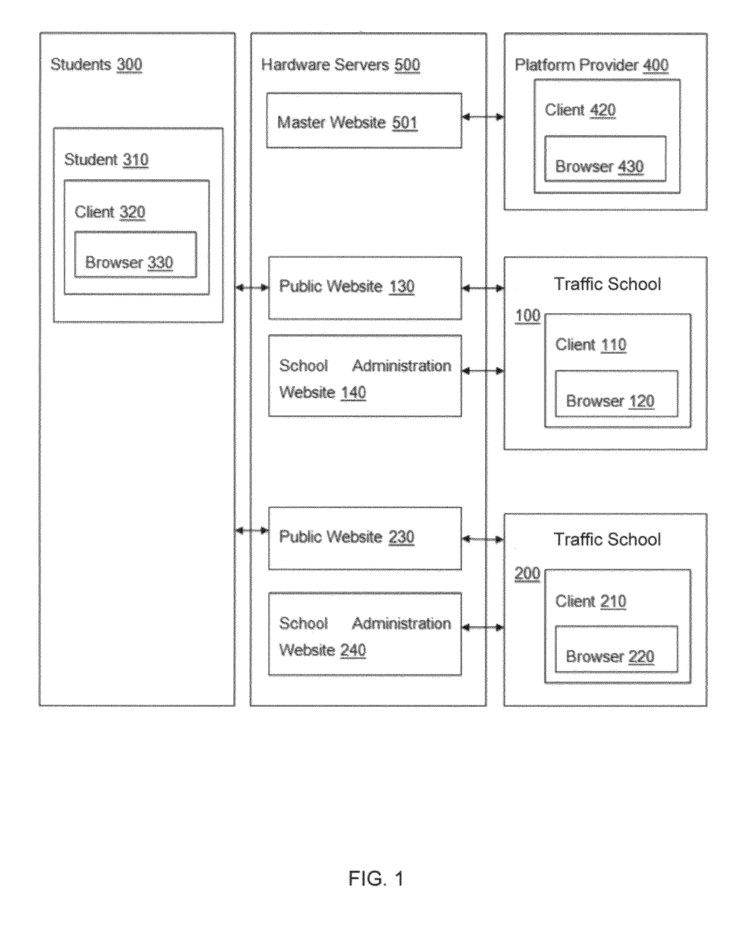

FIG. 1 is a block diagram of a system that may be used to practice the present invention. A plurality of students 300 may communicate with one or more public websites 130, 230 over a computer network, such as the Internet. A platform provider 400 may communicate with a master website 501 over a computer network, such as the Internet. A plurality of traffic schools 100, 200 may communicate with a public website 130, 230 and school administration website 140, 240 over a computer network, such as the Internet. In a preferred embodiment, each traffic school 100, 200 has a dedicated public website 130, 230 and a dedicated school administration website 140, 240.

In a preferred embodiment, a master website 501 may setup a traffic school 100, 200 profile that enables the traffic school 100, 200 to have a school administration website 140, 240. The setup and ongoing management of the public website 130, 230 may be carried out, in real-time, through the school administration website 140, 240. All registrations (transactions) that occur on the public website 130, 230 are captured in, or are passed to, the school administration website 140, 240. Registrations may be performed by students via the public website 130, 230 or via the traffic school's employee via a link from the school administration website 140, 240 to the school's public website 130, 230.

While actions may be attributed to the platform provider 400 and traffic schools 100, 200, it should be understood for the purposes of this specification and claims that the actions may be performed by an employee or designated person of the platform provider 400 or the traffic schools 100, 200 respectively.

A computer network is a collection of links and nodes (e.g., multiple computers and/or other devices connected together) arranged so that information may be passed from one part of the computer network to another over multiple links and through various nodes. Examples of computer networks include the Internet, the public switched telephone network, the global Telex network, computer networks (e.g., an intranet, an extranet, a local-area network, or a wide-area network), wired networks, and wireless networks.

The Master Website 501, public websites 130, 230 and school administration websites 140, 240 may consist of a single webpage or multiple interconnected and related webpages. The websites 501, 130, 140, 230, 240, may reside on one or more hardware servers 500.

The websites 501, 130, 140, 230, 240 may be created using HyperText Markup Language (HTML) to generate a standard set of tags that define how the webpages for the websites 501, 130, 140, 230, 240 are to be displayed.

Students 300 may access the public websites 130, 230; the platform provider 400 may access the master website 501; and each traffic school 100, 200 may access a dedicated public website 130, 230 and a school administration website 140, 240 using software known as an Internet browser 330, 430, 120, 220. Examples of Internet browsers 330, 430, 120, 220 are MICROSOFT INTERNET EXPLORER, GOOGLE CHROME or MOZILLA FIREFOX.

After the browser 330, 430, 120, 220 has located the desired website 501, 130, 140, 230, 240 the browser may request and receive information from a webpage, typically in the form of an HTML document, and then displays the webpage content for the requester on the requester's client 320, 420, 110, 210. The requester may then view other webpages at the same website 501, 130, 140, 230, 240 or move to an entirely different, but permitted, website using the browser 330, 430, 120, 220.

Each student 310, platform provider 400 and traffic school 100, 200 may use a client 320, 420, 110, 210, such as, as non-limiting examples, a cell phone, PDA, tablet, laptop, or desktop computer to access permitted websites via the Internet.

The master website 501, public websites 130, 230 and school administration websites 140, 240 may be hosted or operated from one or more hardware servers 500. The hardware servers 500 may be, as a non-limiting example, one or more Dell PowerEdge(s) rack server(s), HP Blade Servers, IBM Rack or Tower servers, although other types of hardware servers, and/or various combinations of one or more hardware servers may also be used.

A software application may be operated on the hardware servers 500 to handle student registration and day-to-day operations for businesses that offer specialized training or educational services. The software application may be designed, as a non-limiting example, for businesses that operate as traffic schools 100, 200 and may be referred to as a Traffic School Management System (TSMS). This application may be six different software applications in one. While the six different applications may share the same basic design footprint, each may focus on the needs of a slightly different market segment within the traffic school 100, 200 industry.

The six non-limiting examples of different market segments that may be incorporated into the TSMS software are:

Defensive Driving School

Court Ordered School

Traffic Survival School

Student Driver Program

Insurance Discount Program

Corporate/Municipality Program

Typically, within the traffic school industry in the United States, a business (such as a traffic school) only provides services to students 300 in one or two segments versus the six segments of opportunity. These businesses are generally small mom-and-pop type businesses and the software they use only handles one segment of the traffic school market. In many cases, the software used by these businesses is not specific to the traffic school industry and is modified to “work” in their business.

The TSMS software is an application that provides both a public website 130, 230 and a school administrative website 140, 240 that are dedicated to a single traffic school 100, 200. The public website 130, 230 may be customized by each traffic school 100, 200 with respect to website colors, some textual content, images and business rule options without requiring the services of a programmer. The school administrative website 140, 240 is a backend, day-to-day operations management system that works in a seamless, integrated manner with the public website 130, 230. This solution enables businesses in the educational and training markets to operate with maximum efficiency and effectiveness while experiencing substantial cost savings and increased client satisfaction.

The public website 130, 230 meets the informational needs of the students 300 and the functional requirements for registration, class selection, payment processing and self-service account management.

The operations management system integrates the day-to-day business management activities with the public website 130, 230 such that the traffic school 100, 200 can, in real-time, perform the following functions, from the school administration website 140, 240:
Modify website presentation with respect to general design features such as website colors, text, images, offerings and pricing.
Create, modify and cancel classes in four different environments (classroom, online, simulator and behind-the-wheel).
Create and modify package offerings (that enable the combining of class environments with different course offerings and time allocations) (Student Driver Program)
Provide operational management capabilities designed to enable a traffic school to operate more efficiently and effectively on a day-to-day basis.
Manage day-to-day payment processing and funds reconciliation.
Provide an automated student 310 and instructor text and email system with a back-up call management feature.
Provide business executive and operational reporting.
Provide customization of the application with respect to various business options via the “Start Up” process.

The school administration website 140 may be used by the traffic school 100 to create (to some extent) modify and update the traffic school's 100 public website 130 as needed as well as to manage the traffic school's 100 operations on a day-to-day basis. The public website 130 serves as the registration function for both the student 310 (accessing it directly from the traffic school's 100 URL) and for traffic school 100 employees who may access the public website 130 via a link from the school administration website 140. (This may be done to only have to have one registration process and also to be able to track who performed the registration . . . the student 310 via the Internet or the traffic school 100 employee who may have been on the phone with the student 310.)

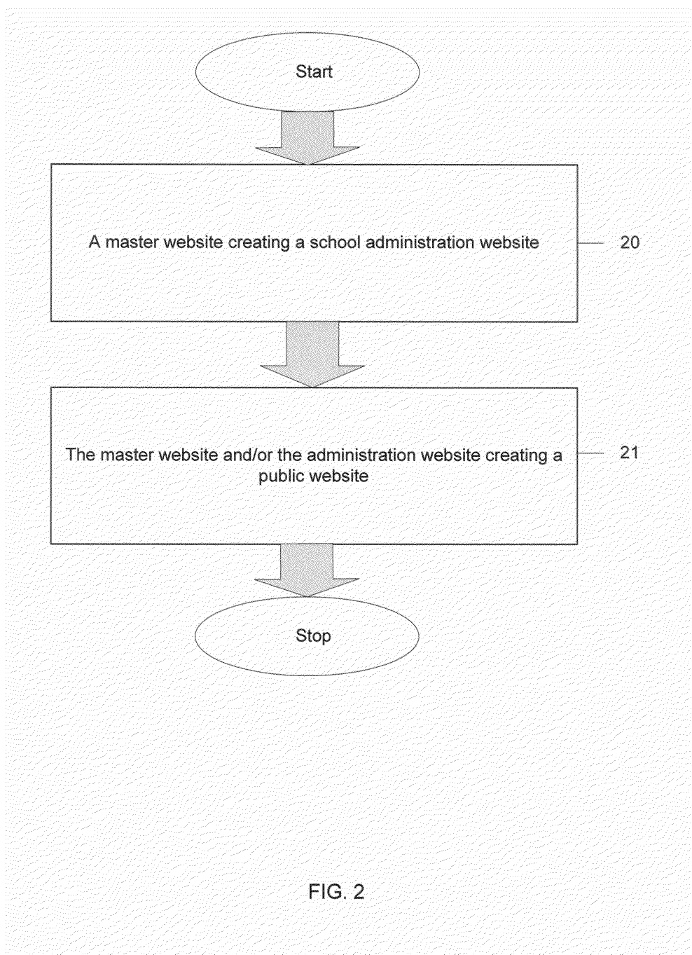

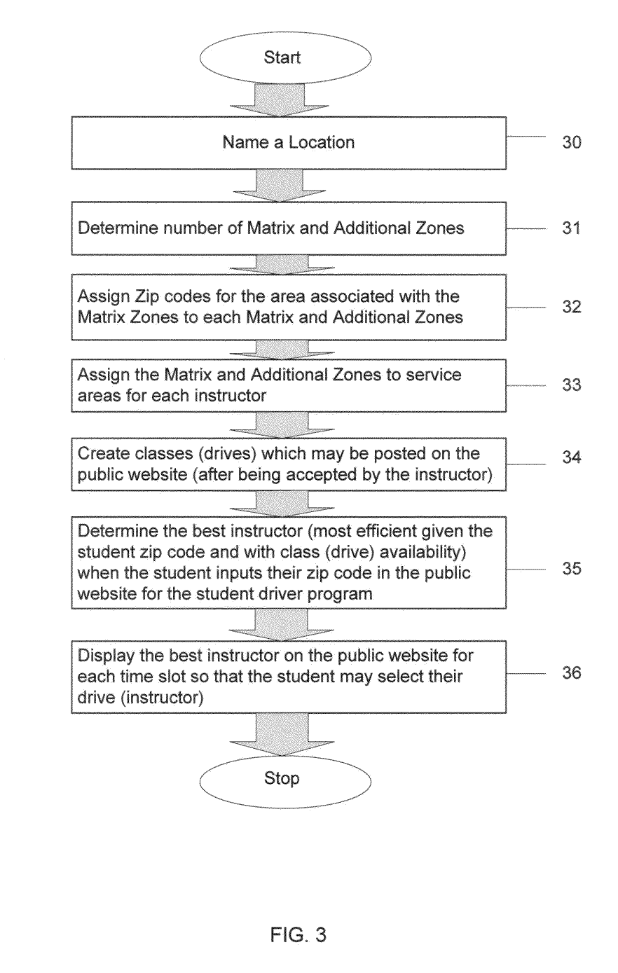

The TSMS application may also include a master website 501. A method of using the master website is illustrated in FIGS. 2-3. The master website 501 is preferably only used by the platform provider 400 and is for the purpose of establishing/setting up new business clients (traffic schools 100, 200) and other associated management functions.

As specific examples, the master website 501 may be used to create a school administration website 140 (Step 20) and the public website 130 (Step 21). In another embodiment, the master website 501 may be used to create a school administration website 140 (Step 20) and the school administration website 140 may then be used to create and modify a public website 130 (Step 21). In both embodiments, the school administration website 140 is preferably accessible by the traffic school 100, but not by the students 300, and the school administration website is able to modify the public website 130. Also in both embodiments, the public website 130 is preferably accessible by the students 300 to register for classes. Further, in both embodiments, information may flow in both directions from the school administration website 140 and the public website 130 in real-time.

The software application may be designed to work in markets where there are needs for continuing education, permits and licenses. As a specific example, the software application may be used by traffic schools 100, 200. Many features and functions (processes) may be incorporated into the software application. These processes may include:
Zone Scheduling (Provides the most efficient and effective scheduling for behind-the-wheel training. This is specific to a student driver program)
Active Calendar (Provides at-a-glance business information with integrated business management functionality)
Real-Time Package Creation (Provides the capability to create or modify package offerings using the school administration website 140, 240 and have them appear real-time on the public website 130, 230. This is specific to the Student Driver Program)
Class Extension (Provides the ability for a traffic school 100, 200 to simply extend classes that are expiring.)
Multifunctional Class Schedules Presentation/Selection (Provides the student 310 or traffic school 100, 200 the ability to sort class information specific to their needs)
Factored Class Creation (Incorporates a set up and scheduling functionality to provide a versatile, effective, efficient and full-proof class scheduling solution)
Change Instructor (Provides the ability for the traffic school 100, 200 to identify and change instructors for any reason in a simple process.)
Change Vehicle (Provides the ability for the traffic school 100, 200 to identify and change vehicle schedules for any reason in a simple process.)
Active Class Completion (Provides the ability for the traffic school 100, 200 to close out a specific class and update the files (Student Record) for each student 310 in the class.)

Zone Scheduling

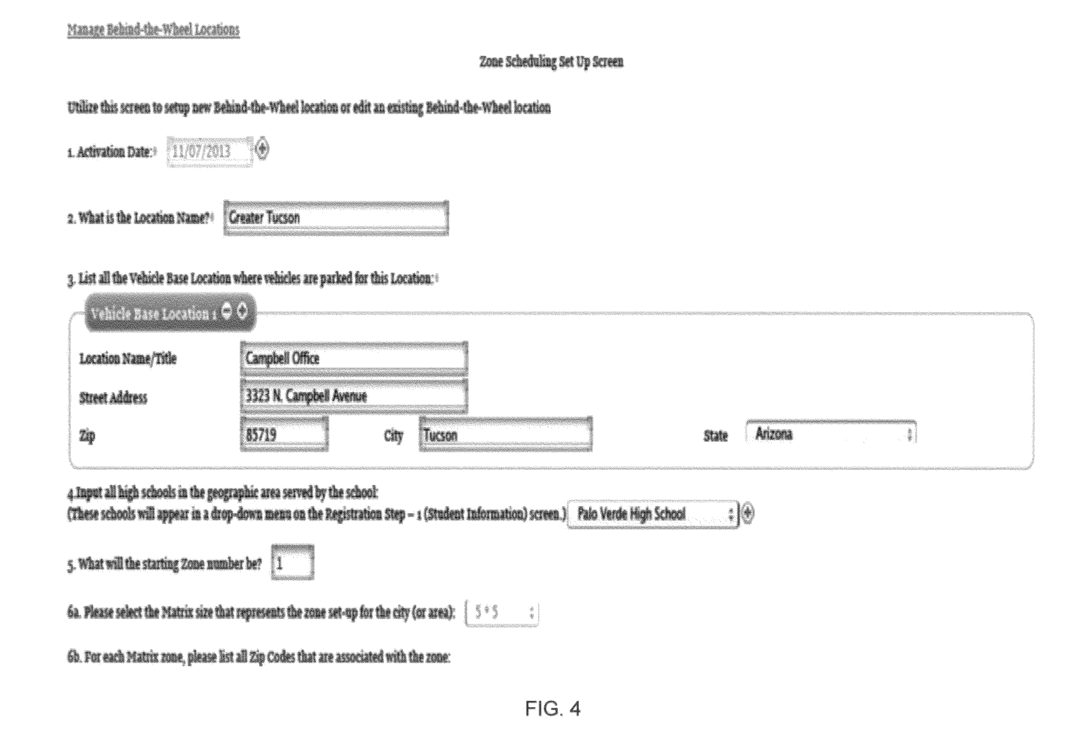

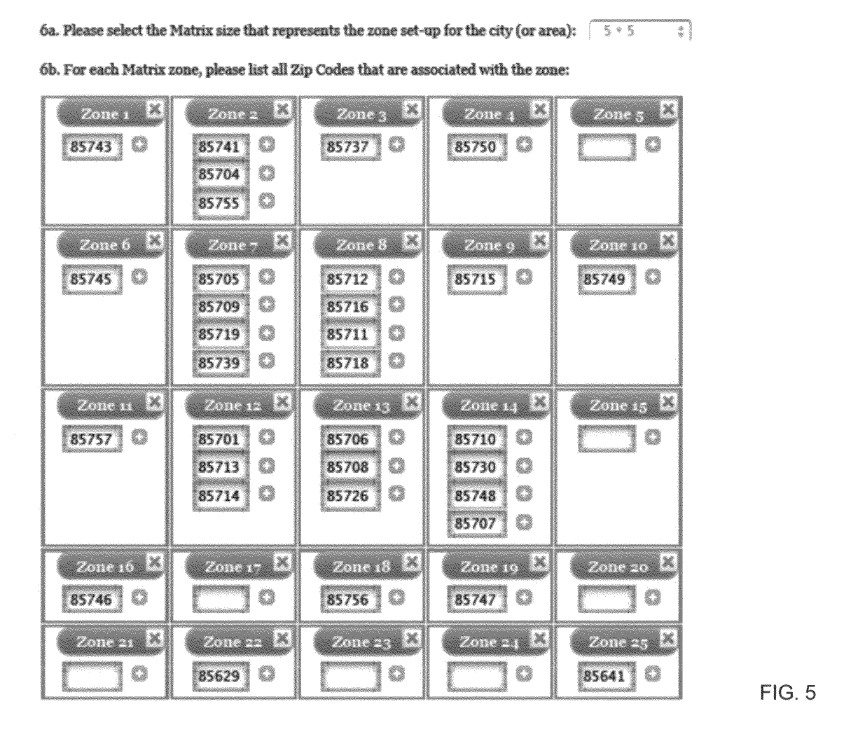

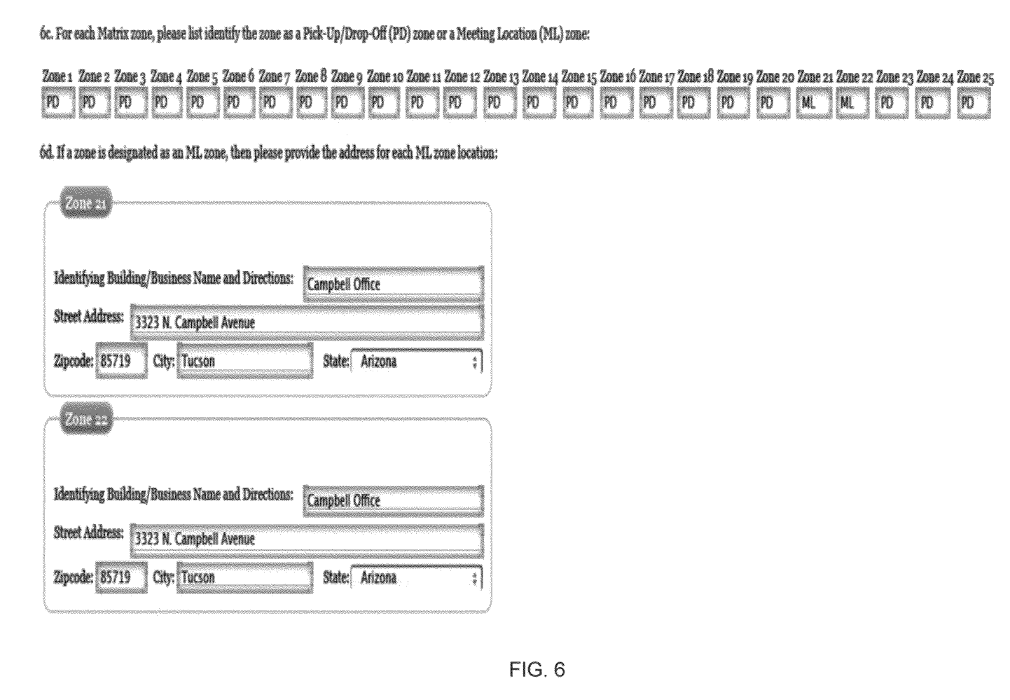

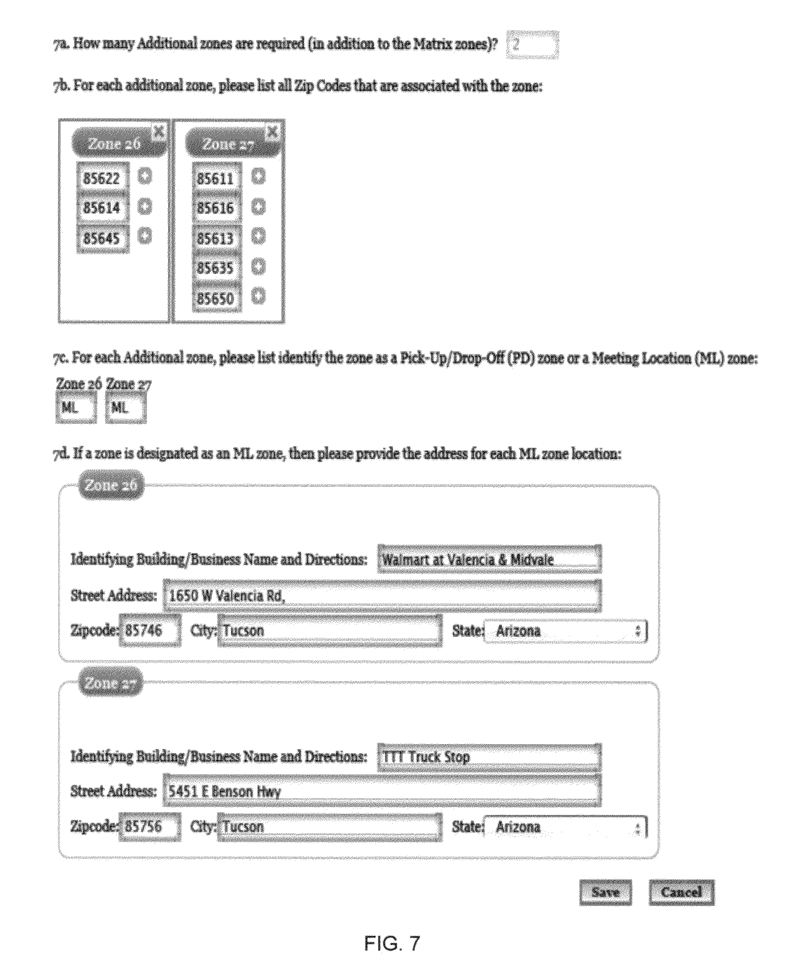

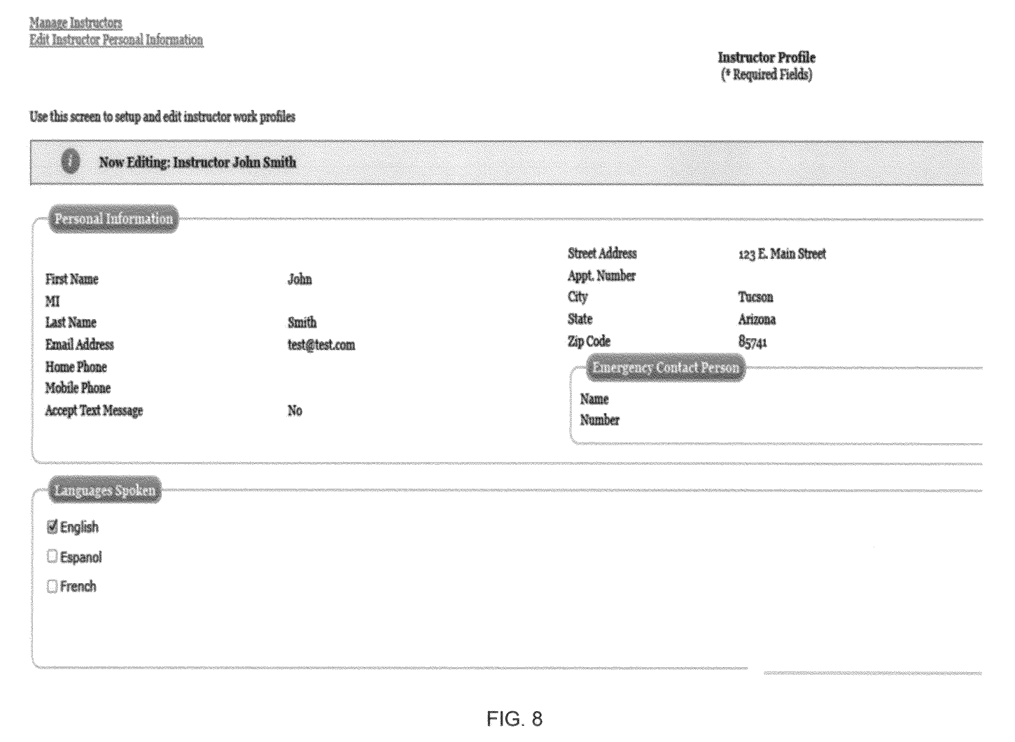

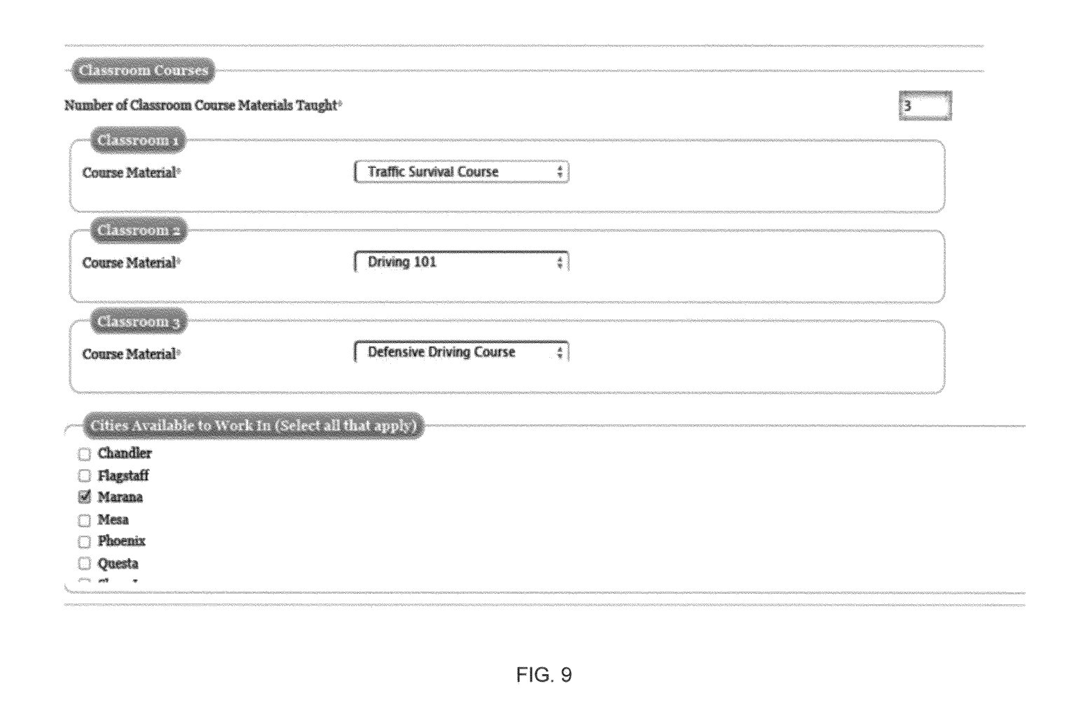

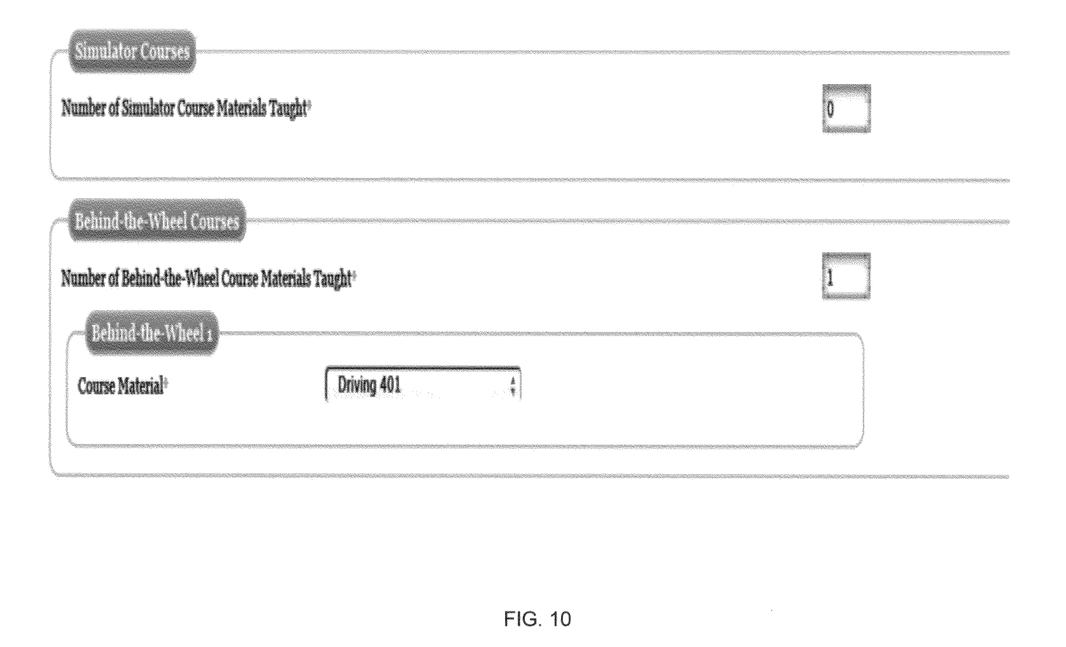

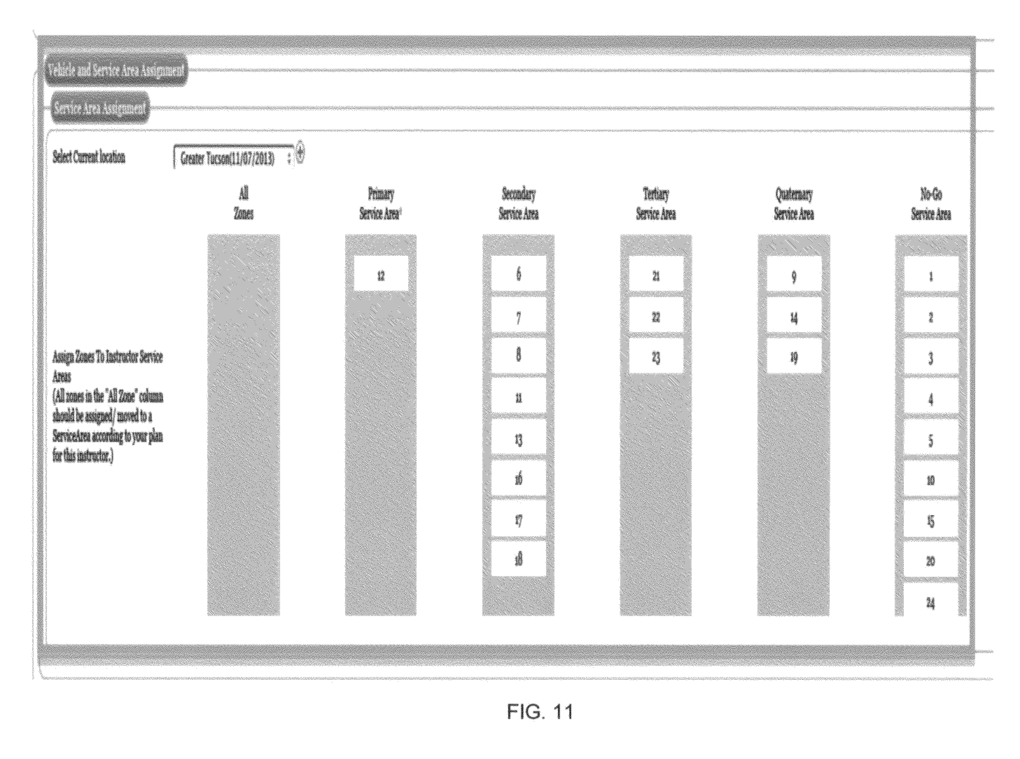

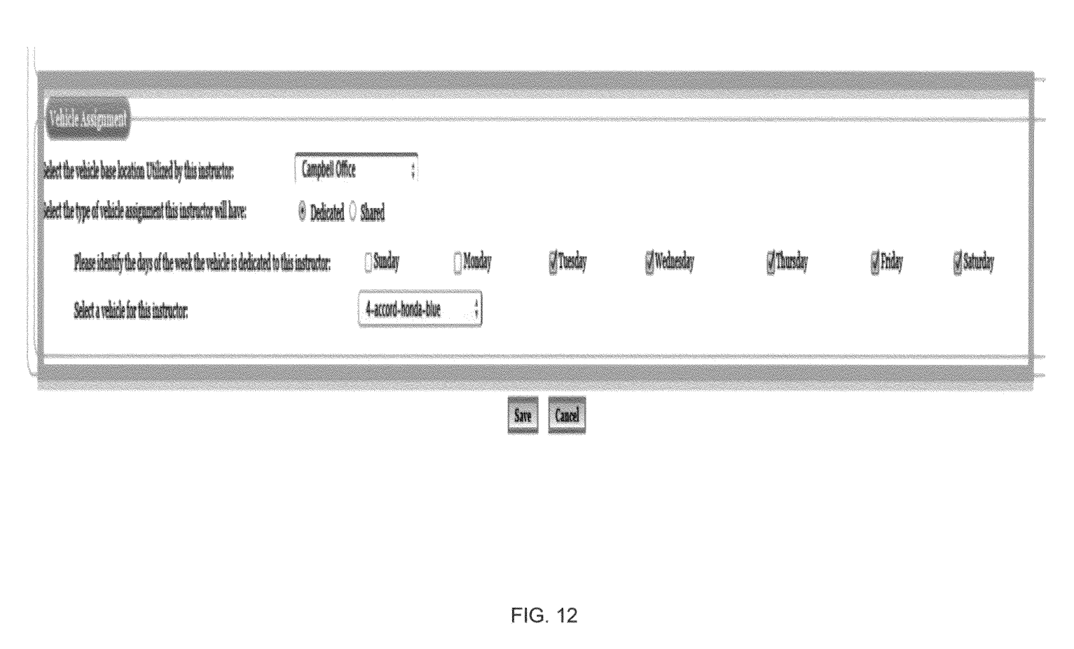

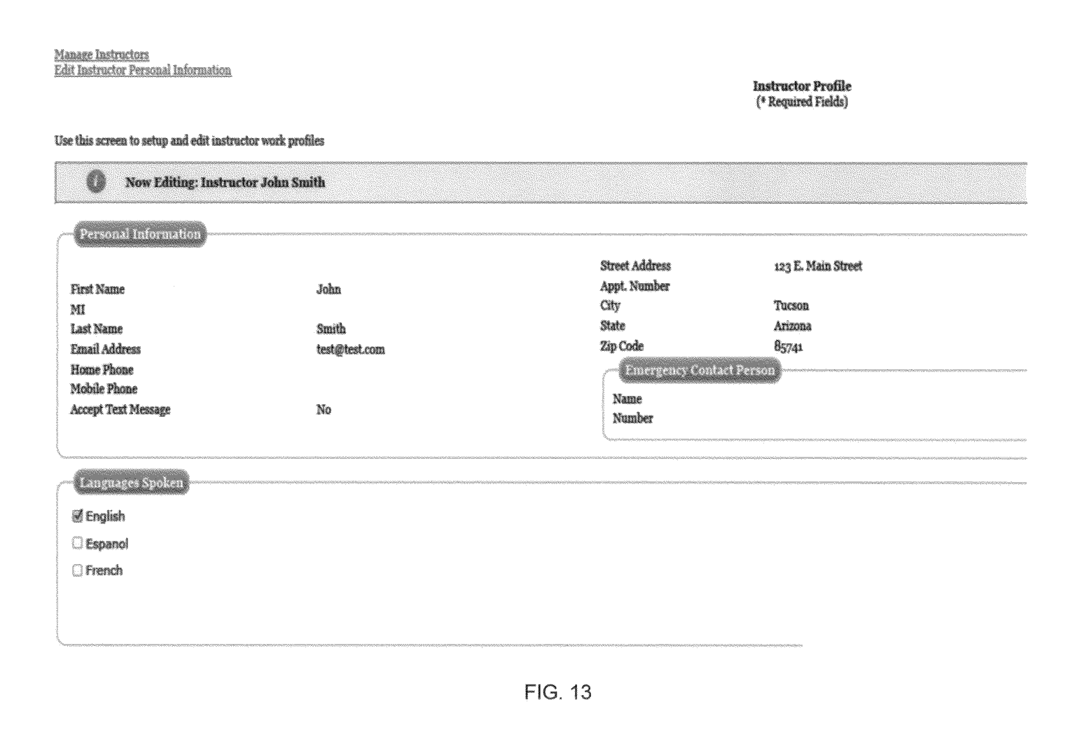

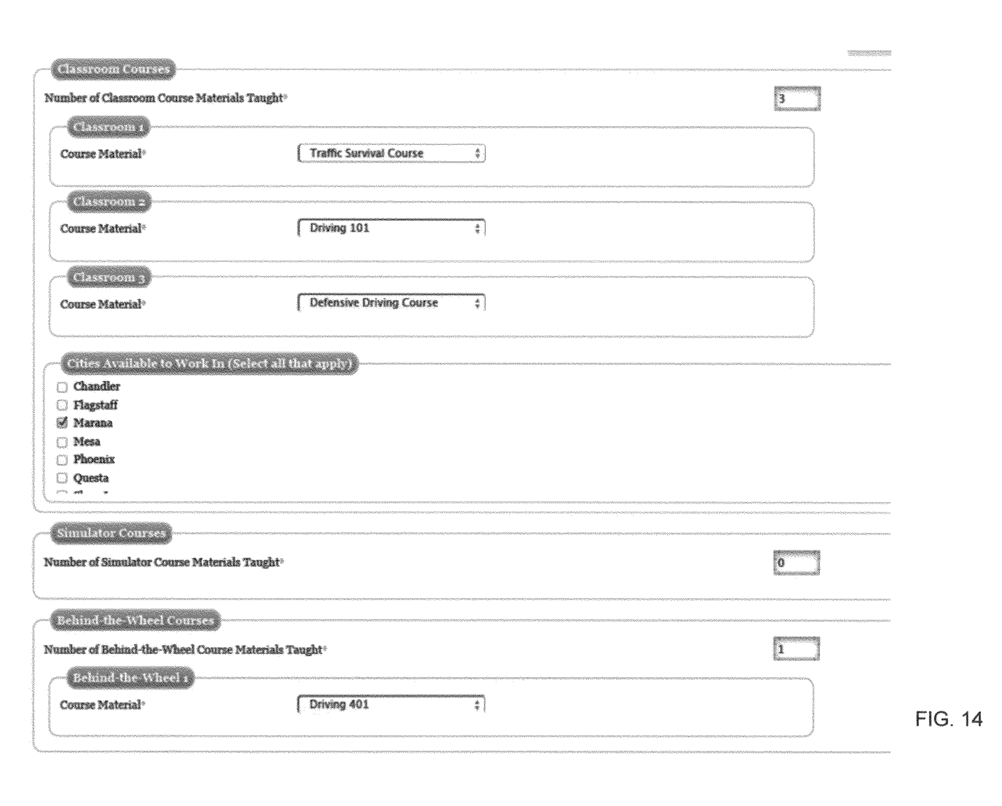

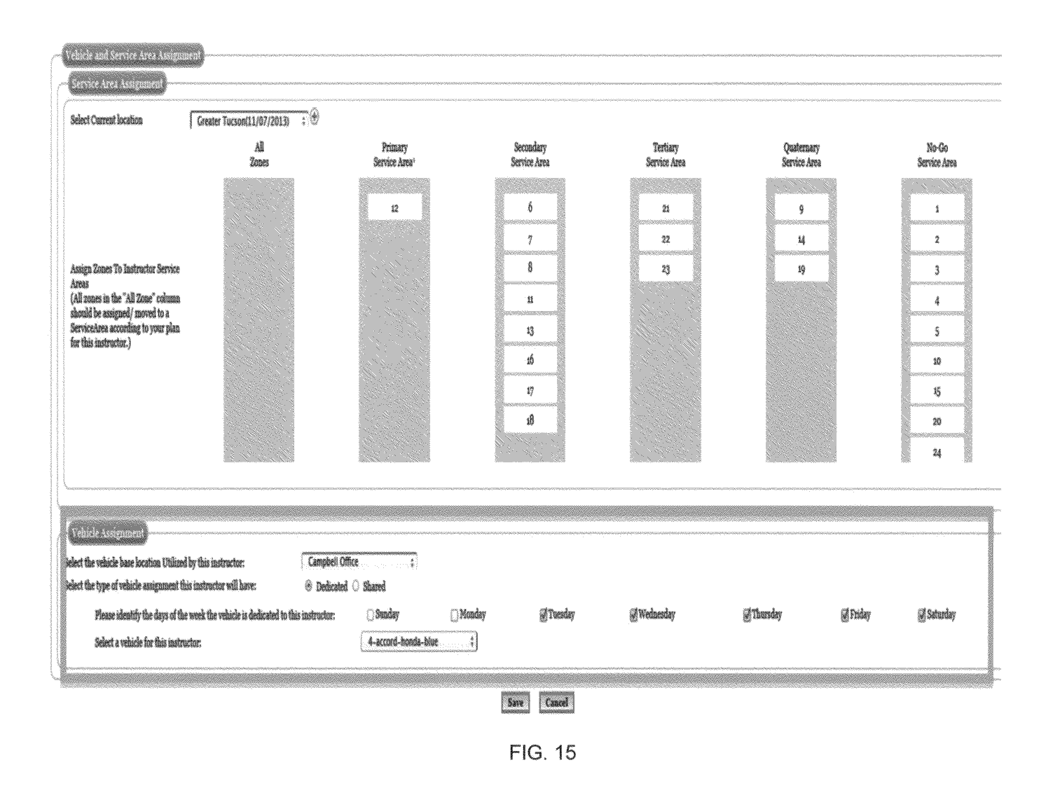

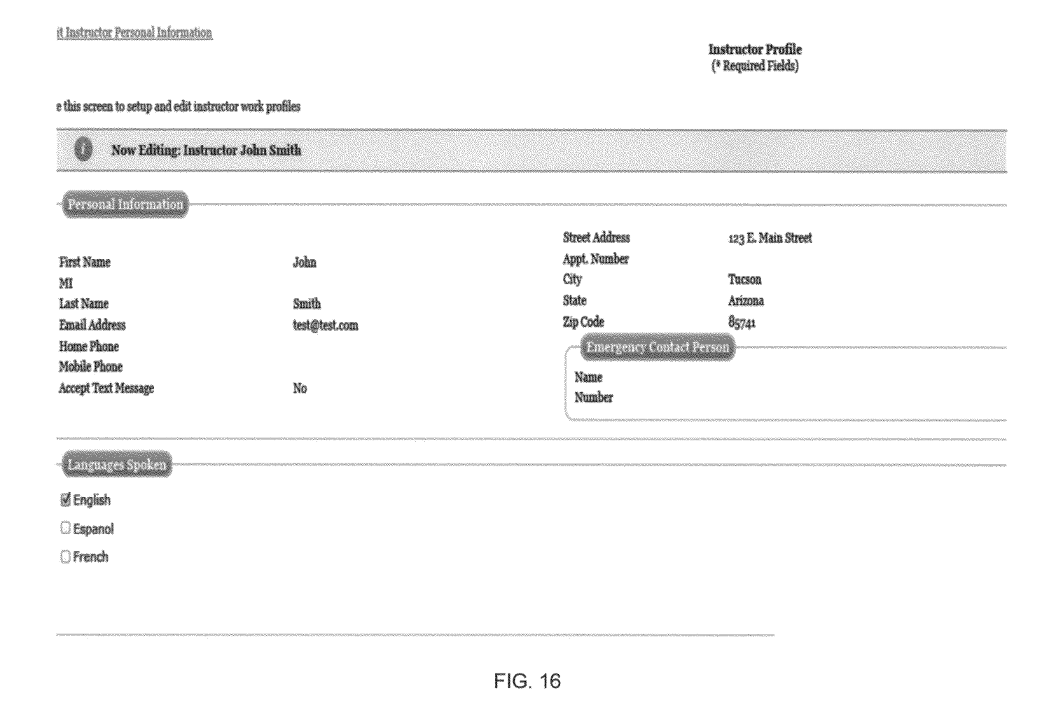

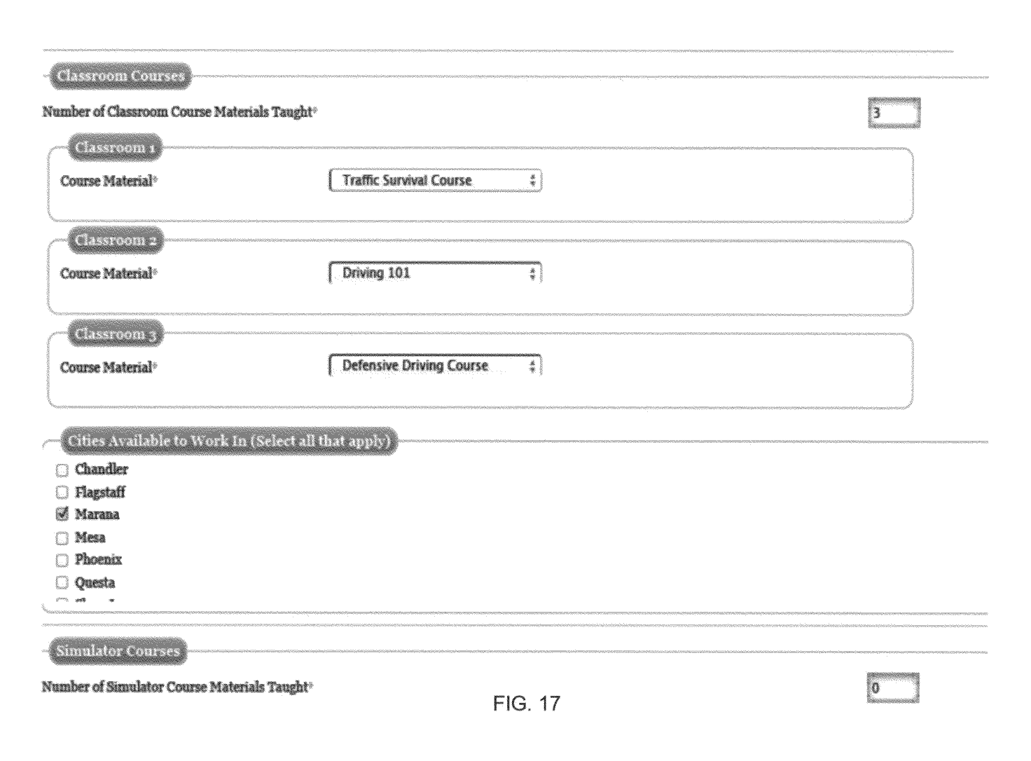

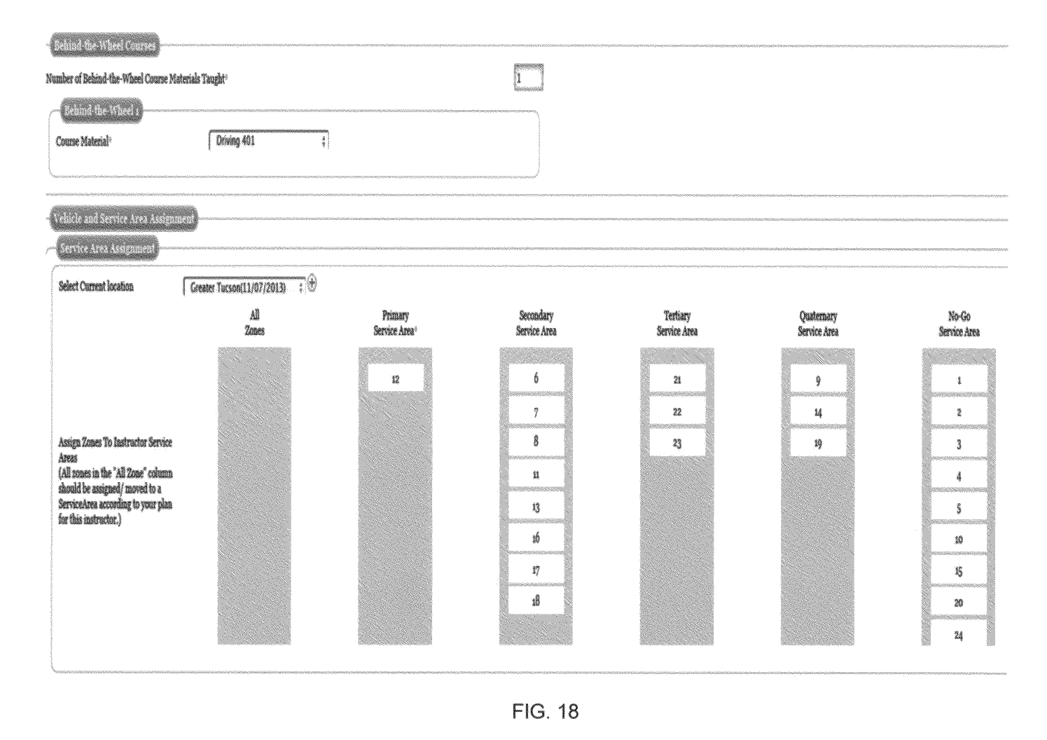

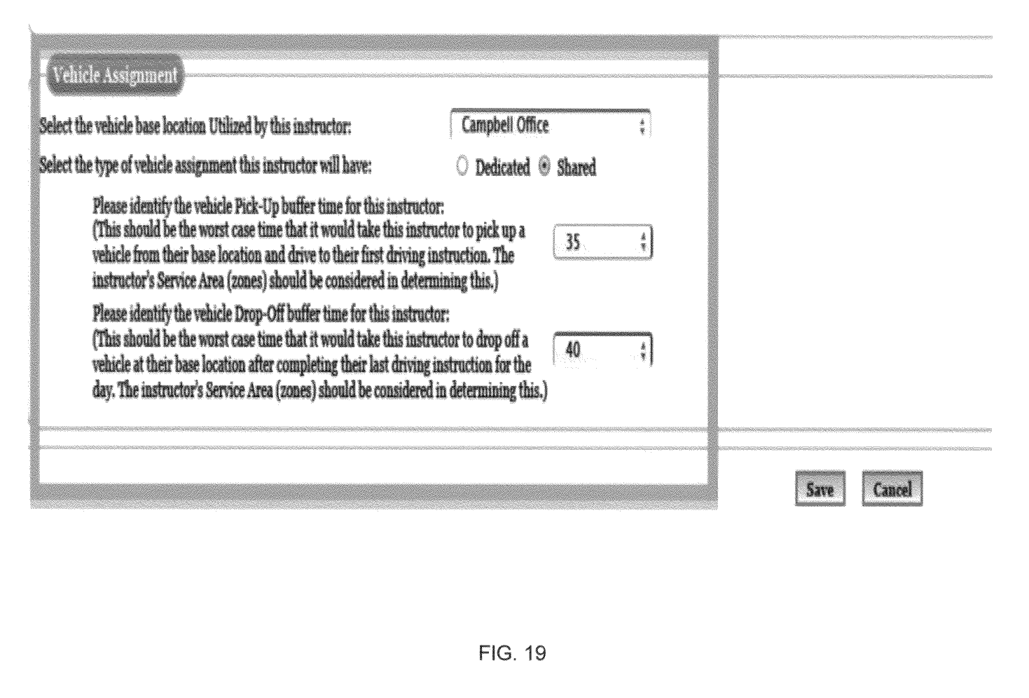

FIGS. 4-19 represent non-limiting examples of screen shots of a possible embodiment for a zone scheduling solution.

The behind-the-wheel (BTW) class scheduling solution incorporates a zone scheduling solution that enables classes (drives) to be displayed on the public website 130, 230 in a manner that meets the needs of the student 310, but is also the most efficient and effective use of instructors in the traffic school 100, 200.

The zone scheduling solution may include one or more of the following processes or functions:
Location creation involving establishment of the relationship between zip codes and zones and the defining if each zone as a “Pick-up/Drop-off” or “Meet at” zone, among other items. (This may be a school administration website 140, 240 function.)
Instructor service area assignment involving the establishment of the relationship between zones and services areas for each instructor (This may be a school administration website 140, 240 function.)
Instructor vehicle assignment involving the assignment of vehicles to instructors on a dedicated or shared basis (This may be a school administration website 140, 240 function.)
Vehicle scheduling involving the reservation of vehicle time based on the type of vehicle assignment, the drive (class) times for the vehicles and the “pick-up” and “drop-off” buffer times required for each instructor ((This may be a school administration website 140, 240 function.)
Class (drive) creation involving the creation of a drive based on the course material being taught, the language the class is being taught in, the location in which the drive is being scheduled/taught, the vehicle being utilized, the instructor being scheduled (all selections being compatible) and identification of days or dates and times of day for the drives (all verified as available with respect to the instructor and vehicle) (This may be a school administration website 140, 240 function.)
Class (drive) display involving the presentation of the most efficient instructor with the available class time slot in question for the given zip code of the student. (This may be a public website 130, 230 function.)

The presentation of the behind-the-wheel drives on the public website 130, 230 is different than that of the classroom and simulator environments (and of course the online environment). This is because unlike the classroom or simulator classes where ALL classes are preferably displayed, the BTW drives preferably only display one class at a time for each day/start time combination based on the best available instructor (from an efficiency perspective for the traffic school 100, 200 based on the student's 310 zip code/zone information).

Preferably, in every case, only the most efficient instructor (as determined by the traffic school's 100, 200 zone scheduling solution) that has an available drive is displayed on the public website 130, 230 for each time slot (or drive) for each day. In other words, as an example, if there are six instructors whom all have drives (classes) Monday-Friday at 8:00 am-10 am, all six classes would not be displayed on the traffic school's 100, 200 public website 130, 230 at the same time for the same class time. Only the most efficient instructor's class would appear on the school's public website 130, 230 for the 8:00 am time slot given the relationship established between all six instructors with respect to the most efficient instructor to service a particular student in a specific zip code (as determined by the zone scheduling logic given the student's 310 zip code).

Once a class (drive) has been selected by a student 310, the system then seeks to replace that open slot in the class schedules displayed on the public website 130, 230 with the next best instructor (again, as defined by the traffic school 100, 200 in the zone scheduling process given the student's 310 zip code).

The benefits to the traffic school 100, 200 of zone scheduling may be that, to the extent desired by each school 100, 200, the application allows for schools 100, 200 to most efficiently manage their business by presenting the most efficient available instructor to the student on the school's public website 130, 230 regardless of whether they pick up and drop off students 300 or require the students 300 to meet at a specified location or a combination of the two business models.

Another benefit of zone scheduling may be that by always displaying the most effective and efficient instructor for the drive on the traffic school's 100, 200 public website 130, 230, this enables the most efficient use of instructor time by minimizing their drive time to pick up students 300, and reduces the traffic school's 100, 200 expenses for gas, oil changes, tires and general wear and tear on vehicles.

Another benefit of zone scheduling may be that it displays an instructor for time slots (drives) until such time as no additional capacity (instructors) exist for the specific time slot. In other words, the Zone Scheduling process preferably never wastes capacity and always maximizes the use of instructors and vehicles in the most efficient and effective manner.

Another benefit of zone scheduling may be that it allows the student 310 to be picked up and dropped at a location of their choice (ex: home or high school), or directs the student 310 to meet their instructor at a specified location (ex. traffic school's 100, 200 place of business or another specified location.)

Another benefit of zone scheduling may be that it is 100% customizable to each traffic school's 100, 200 specific needs and the area they operate in.

Another benefit of zone scheduling may be that it enables traffic schools 100, 200 to expand outside their current base of operations without requiring additional software to do so.

Another benefit of zone scheduling may be that it provides a sophisticated yet easy to use solution that requires minimal time to set up and manage operations.

The zone scheduling solution may be a combination of uniquely designed and integrated processes. The solution may start with the traffic school 100, 200 determining the area(s) they wish to service. (Each area will become a “Location” in the TSMS software application.)

Whether a traffic school 100, 200 has more than one “Location” will depend on a number of factors, including, but not necessarily limited to, the following: physical size of area, number of instructors, number of vehicles, quality of roadways, ease of access within the “Location” and relative location of each “Location” (such as different cities).

The traffic school 100, 200 may then determine the number of “Zones” that they wish to have for the “Location”. The number of “Zones” may be determined, as a non-limiting example, by the matrix size the traffic school 100, 200 elects to use. These “Zones” will be referred to as “Matrix Zones”.

The matrix may be a 1×1 (or simply 1 large zone), 10×10 (or 100 zones) or more. The matrix size is determined by a number of factors that are given consideration. These factors include, but are not limited to: the total area of the Location, number of instructors, number of vehicles, mobility (based on streets, freeways, mountain ranges, waterways and other natural or man-made restrictions), the business model of the traffic school 100, 200 and the desired maximum time between drives.

Once the traffic school 100, 200 determines the number of “Matrix Zones” they desire for a “Location” they may, as a non-limiting example, overlay (draw) the Matrix Zones (roughly equal in size) over a zip code map of the area in question (the “Location”) to create a Zone Map. The traffic school 100, 200 may then record the zip codes that “fit” within each zone.

The zip codes may not match up exactly with the lines that define each zone, but that is not important as we are simply trying to establish relationships between “Zones” (and associated zip codes). Zip codes are preferably NOT associated with more than one Zone. The traffic school 100, 200 may use its best judgment when assigning a zip code to a Zone.

The traffic school 100, 200 may add or remove Locations; remove or add Zones within a Location; change, remove or add zip codes to Zones as they fine tune their custom zone scheduling solution.

A “Location” may also have additional zones that are not part of the “Matrix Zones”. These zones represent service areas where their boundaries do not touch any of the zones in the “Matrix Zones”. These zones are called “Additional Zones”. There is no limit to the number of “Additional Zones” a traffic school 100, 200 may have within a “Location”.

A traffic school 100, 200 may create “Additional Zones” versus a new “Location” based on the fact that an instructor is preferably only assigned to one “Location”. This means that the number of instructors a traffic school 100, 200 has and the school's desire to utilize instructors as backup for other instructors may be used to drive the use of “Additional Zones” versus additional “Locations”.

Once the traffic school 100, 200 determines the number of “Additional Zones” they desire for a “Location” they may overlay (draw) the Additional Zones (roughly equal in size) over a zip code map of the area in question to create a “Zone Map” for the “Additional Zones”.

The traffic school 100, 200 may then record the zip codes that “fit” within each “Additional Zone.” The zip codes may not match up exactly with the lines that define each zone, but that is not important as we are simply trying to establish relationships between “Zones” (and associated zip codes).

Zip codes preferably are not associated with more than one Zone. The traffic school 100, 200 may use its best judgment as to which Zone the zip code should be assigned to.

At this point the traffic school 100, 200 may utilize the TSMS application to create a “Location” in the system. The traffic school 100, 200 may be taken through the following non-limiting list of questions and items in order to complete the “Location” set up: What is the activation date for this Location? What is the Location name? List all vehicle base locations where vehicles are parked for the Location. Input all high schools in the geographic area served by the traffic school 100, 200 (for this Location). The system will proved a starting Zone number for the “Location.” Select the matrix size for this Location. For each Matrix Zone, list the zip code(s) that are associated with the zone. For each Matrix Zone, identify if the zone is a “Pick-up/Drop-off” zone or a “Meeting Location” zone. For each “Meeting Location” zone, identify the meeting address.

The TSMS application may also ask how many “Additional Zones” are with the “Location”? For each “Additional Zone” list the zip codes associated with the zones. For each “Additional Zone,” identify if the zone is a “Pick-up/Drop-off” zone or a “Meeting Location” zone. For each “Meeting Location” zone, identify the meeting address.

There are two types of business models that the TSMS application may support. One is where the traffic school 100, 200 picks up and then drops off a student 310 at a location specified by the student 310 such as their home or the student's high school (with some constraints). The second is where the traffic school 100, 200 specifies that the student 310 meet the instructor at a specified location such as the school's business address or a third party meeting location. The TSMS application may support either business model and/or a combination of the two.

At this point, the traffic school 100, 200 may utilize the Instructor Profile sub-menu item to create the Service Areas for each instructor. Within the Instructor Profile screen the traffic school 100, 200 may move to the “Behind-the-Wheel Courses” section and identify how many behind-the-wheel classes (different courses) that the instructor teaches. The traffic school 100, 200 may then selects the course material that is taught.

The system may now display the “Vehicle and Service Area Assignment” section. Once a “Location” is selected for an instructor, the application places all the Zones associated with the “Location” selected into the “All Zones” column of the section.

The traffic school 100, 200 may then simply “drag and drop” each of the school's Zones into one of five Service Areas. These Service Areas may be used to determine the priority in which the application's logic considers the instructor to be displayed versus other instructors with respect to the student's 310 zip code and associated Zone.

The traffic school 100, 200 may then completes the Vehicle Assignment section. The traffic school 100, 200 may select the vehicle base location that will service the instructor in the Vehicle Assignment section. This is the location that the instructor will pick up or drop off the vehicle used in their drives. The vehicle may be assigned to the instructor as either a “Dedicated” or “Shared” vehicle. A Dedicated vehicle is assigned 100% of the time each day (24 hours) for the days that are identified by the traffic school 100, 200 by selecting any day(s) of the week.

The traffic school 100, 200 may then select a vehicle for the instructor. At this point the application may allocate the vehicle to the instructor in the vehicle calendar and begins to track all remaining available time for the vehicle.

A Shared vehicle is assigned to the instructor for the time period associated with their class AND the Pick-up and Drop-off buffer time required.

The traffic school 100, 200 may select the pick-up buffer time that basically becomes an additional time frame BEFORE the first drive of the day that a vehicle is reserved for the instructor. This is to allow time for the instructor to drive to their first drive (if need be versus the student 310 meeting at the traffic school's 100, 200 business location). The application may provide a drop-down menu to select a time of, as non-limiting examples, between 10 and 90 minutes for the pick-up buffer.

The traffic school 100, 200 may select the drop-off buffer time that basically becomes an additional time frame AFTER the last drive of the day that a vehicle is reserved for the instructor. This is to allow time for the instructor to return the vehicle to the vehicle base location from their last drive (if need be versus the student 310 having come to the traffic school 100, 200's business location). The application may provide a drop-down menu to select a time of, as non-limiting examples, between 10 and 90 minutes for the drop-off buffer.

The system may automatically reserve vehicle time on the vehicle calendar at the time of class creation.

When the vehicle is a “Shared” vehicle, the system checks for availability of vehicles when classes are being created and then reserve the time for the vehicle on the vehicle calendar if the traffic school 100, 200 proceeds with class creation. (Note: “Dedicated” vehicles may be reserved in the vehicle calendar at the time of assignment to an instructor in the instructor profile.)

At some point, the traffic school 100, 200 may use the TSMS application class creation process to create classes/drives. When classes are being created the system may determine if the vehicle is “Dedicated” or “Shared” for the drives being created. If the vehicle is designated as being “Shared,” the system may search for an available vehicle and once accepted by the traffic school 100, 200 the system reserves the drive time PLUS the pick-up and drop-off buffer times in the vehicle calendar.

At this time, when a student 310 accesses the traffic school's 100, 200 public website 130, 230 and enters their zip code, the application then associates the zip code with a zone which in turn is associated with a “Location”. The application then uses logic to identify one instructor working in the “Location” (based on the instructor service area assignments and availability) per time slot per day to present to the student 310 as a class/drive option. The zone scheduling process results in the most efficient instructor that is currently available to provide the specific course being presented to the student 310. As defined by the traffic school 100, 200, the zone scheduling process preferably always maximizes the use of instructors and vehicles in the most efficient and effective manner and never wastes capacity.

In another embodiment, Zip codes may be assigned to Zones, Zones (either “matrix” or “additional”) may be assigned to Service Areas for each instructor and Service Areas (for each instructor) may be assigned to Locations.

In another embodiment, the process may be: 1) naming a Location (Step 30), 2) deciding how many Matrix Zones you want (Step 31), 3) assigning Zip codes for the area associated with the Matrix Zones to each Matrix Zone and then do the same for Additional Zones (Step 32), 4) assigning the Matrix and Additional Zones to Service Areas for each instructor (Step 33), 5) creating classes (drives) which may be posted on the public website 130 (after being accepted for or by the instructor) (Step 34), 6) determining the best instructor (most efficient given the student zip code and with class (drive) availability) when the student inputs their zip code in the public website 130 for the student driver program (Step 35) and 7) displaying on the public website 130 for each time slot so that the student may select their drive (instructor) (Step 36).

Active Calendar

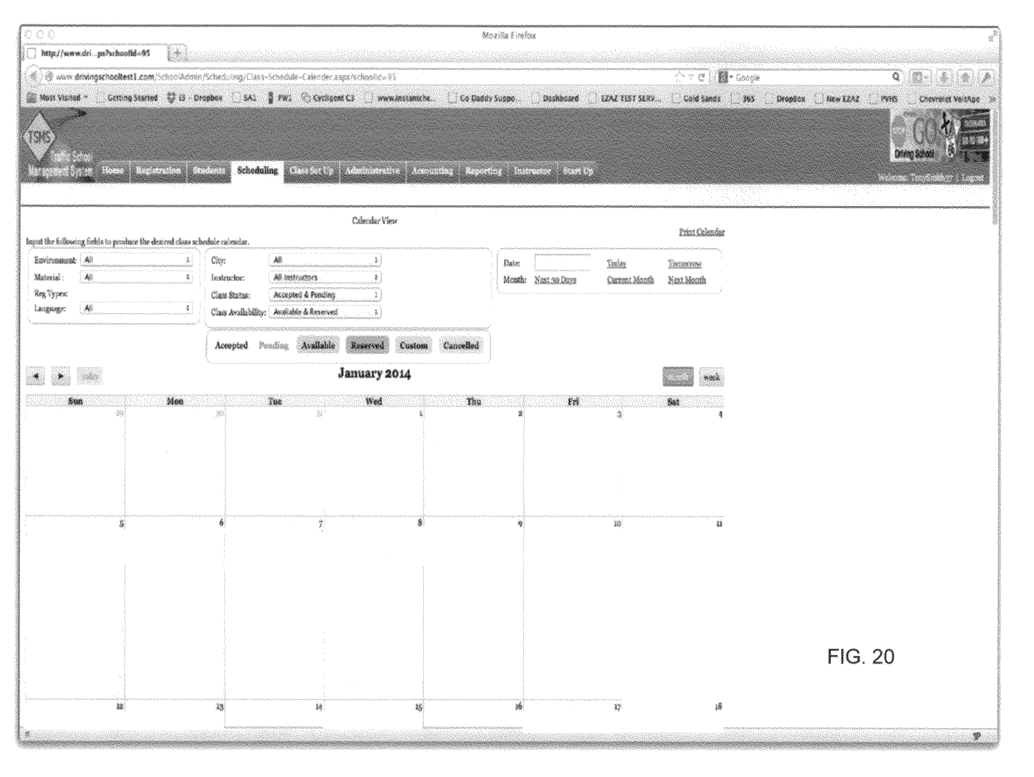

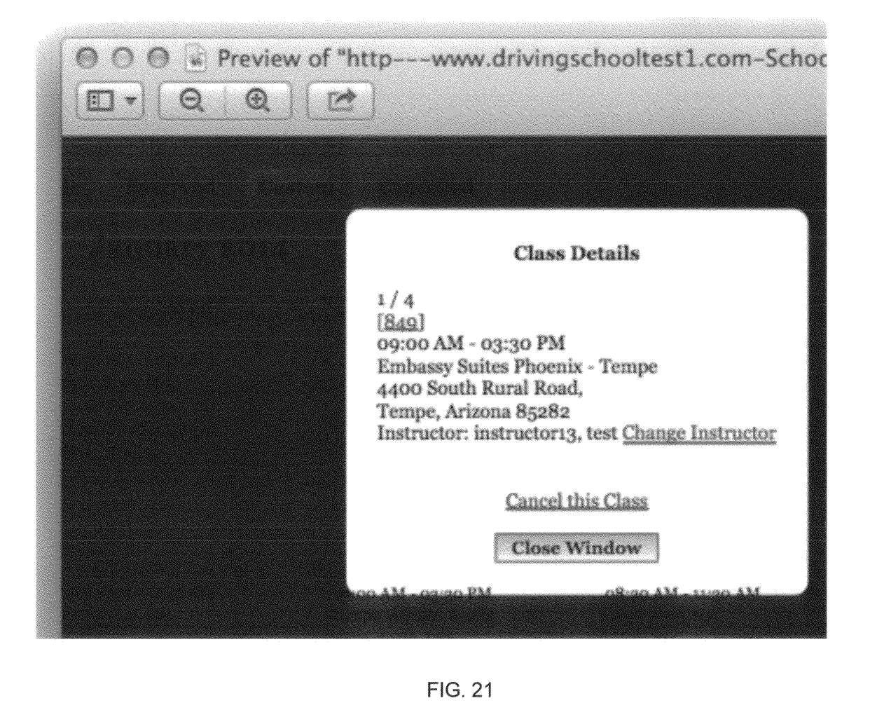

FIGS. 20-21 represent non-limiting examples of screen shots of one possible embodiment for an active calendar.

The Active Calendar function provides a visual view of all the classes created by the student driving school 100, 200 and their current status in a unique manner such as to provide meaning to the display of classes that would not otherwise be observable without the user taking some type of action. Additionally, the active calendar provides integrated business management functionality that is not a part of a calendar function. This is in addition to the Manage Class function, which may provide the same list of classes except that they are presented in a report or spreadsheet format.

As non-limiting examples, a color-coded display of information associated with each class may be presented in its own “box”. Black text may indicate that the class has been “Accepted” by the instructor. Red text may indicate that the instructor has NOT accepted the class as of yet and that the class is still “Pending”. A blue box around the text may indicate that the class has not reached its capacity for students 300. A green box around the text may indicate that the class has reached its capacity for students 300 and no additional students 300 can be added to the class. A yellow box around the text may indicate that the class was created specifically for a student 310. A pink box around the text may indicate that the class was cancelled by the traffic school 100, 200. (This is not to be confused with the student 310 cancelling their specific class.)

Links associated with each class (that can be viewed by simply clicking on the class) may be used to provide the following functionality: by clicking on the class ID link the system may take the traffic school 100, 200 to the Class Summary screen; by clicking on the “Change Instructor” link, the traffic school 100, 200 can access that Change Instructor function; and by clicking on the “Cancel this Class” link, the traffic school 100, 200 can cancel the class, by clicking on the “Change Vehicle” link the traffic school 100, 200 may access that Change Vehicle function.

In the active calendar process, when the class is cancelled the students 300 and instructor may all be notified by text message, email and/or telephone (based on student 310 and instructor preferences.)

A possible benefit of active calendar may be that at a glance the traffic school 100, 200 can determine or execute the following:

First, if a class has been “accepted” by an instructor or is still “pending” an instructor's acceptance.

Second, if a class has been “accepted” by an instructor then the traffic school 100, 200 knows that the class is being displayed on the public website 130, 230 (if its within the traffic school's 100, 200 chosen time period of display).

Third, if a class is “pending” an instructor's approval, then the traffic school 100, 200 knows that the class is not being displayed on the traffic school's public website 130, 230 as an available class for a student 310 to select.

Fourth, if a class is “Available” or is “Reserved”.

Fifth, if a class is “Available” that means that the capacity of the class has not been reached. In this case the class is still being displayed on the traffic school's 100, 200 public website 130, 230 for a student 310 to select.

Sixth, if a class is “Reserved” that means that the class has reached its capacity. In this case the class is no longer being displayed on the traffic school's 100, 200 public website 130, 230 for a student 310 to select.

Seventh, if a class is a “Custom” class. If a class is a “Custom” class that means that it has been created specifically for a student 310 and does not appear on the traffic school's public website 130, 230.

Eighth, if a class has been “Cancelled”. Cancelled classes appear on the active calendar until the date of the class has passed. This is to provide visibility to traffic school's 100, 200 in case a student 310 has a question about a cancelled class.

Ninth, the active calendar provides the ability to develop the desired class calendar.

Tenth, the active calendar allows the traffic school 100, 200 to create the calendar that best meets their needs by selecting the view options from the following eight (8) items: environment, material, language, city, instructor, class status, class availability and date or date range.

Eleventh, the active calendar may provide the ability to access the specifics about a class by allowing the traffic school 100, 200 to view the Class Summary screen for a specific class by simply clicking on the class ID link (located in the pop-up display).

Twelfth, the active calendar may provide the ability for the traffic school 100, 200 to access the Change Instructor screen (process) for a specific class or many classes for a specific instructor by clicking on the “Change Instructor” link (located in the pop-up display).

Thirteenth, the active calendar may provide the ability for the traffic school 100, 200 to cancel the specific class by clicking on the “Cancel Class” link (located in the pop-up display).

And fourteenth, the active calendar may provide the ability for the student driving school 100, 200 to access the Change Vehicle screen (process) for a specific class (drive) or many classes (drives) for a specific vehicle by clicking on the “Change Vehicle” link (located in the pop-up display).

Real-Time Package Creation Process

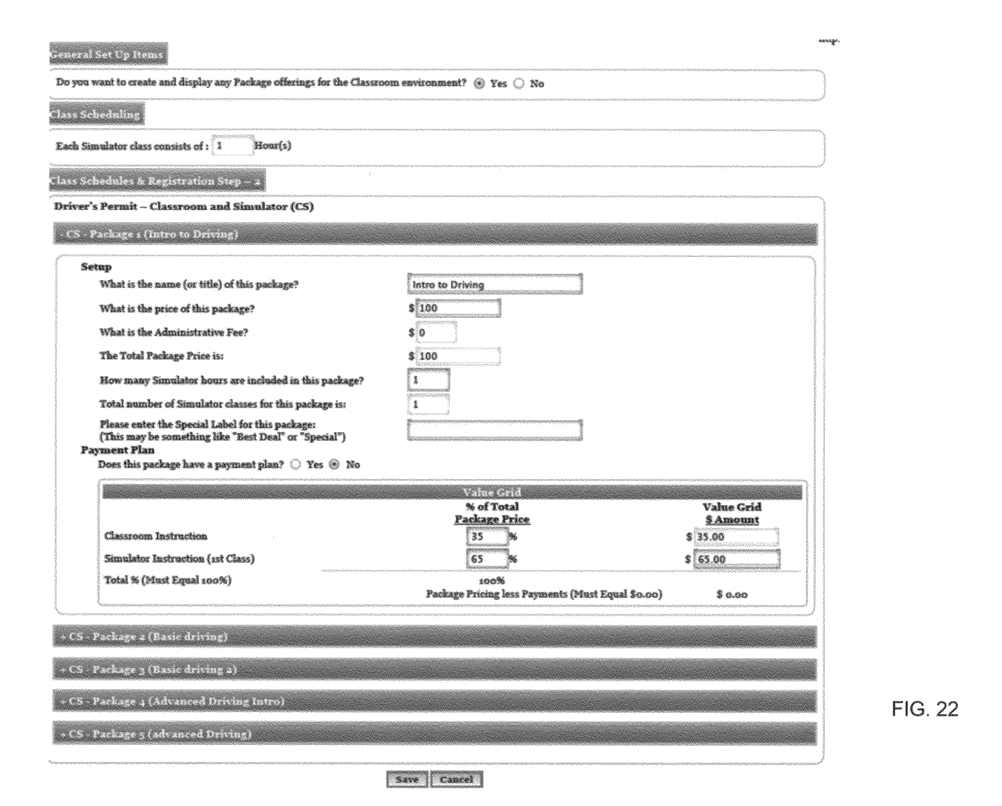

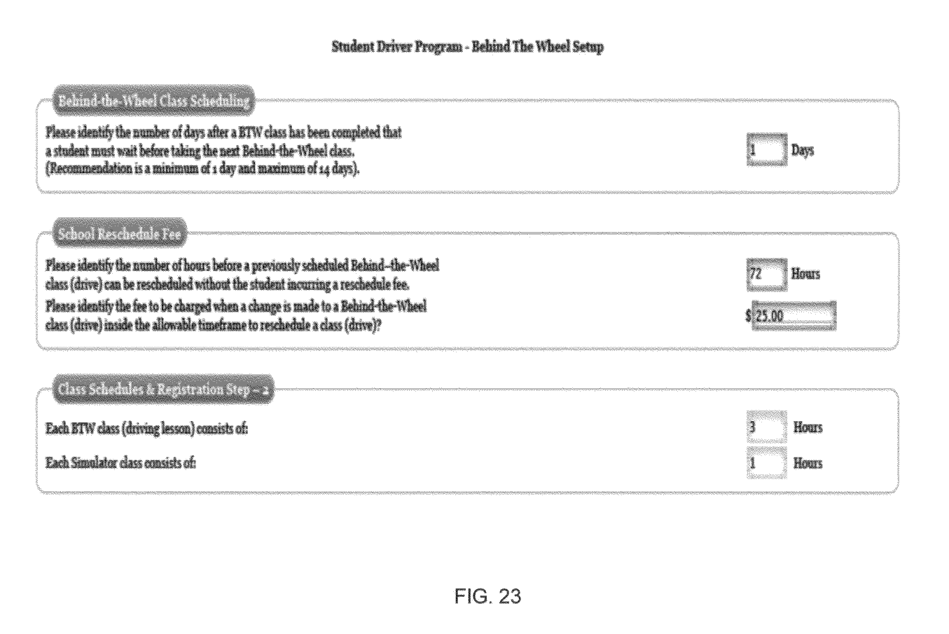

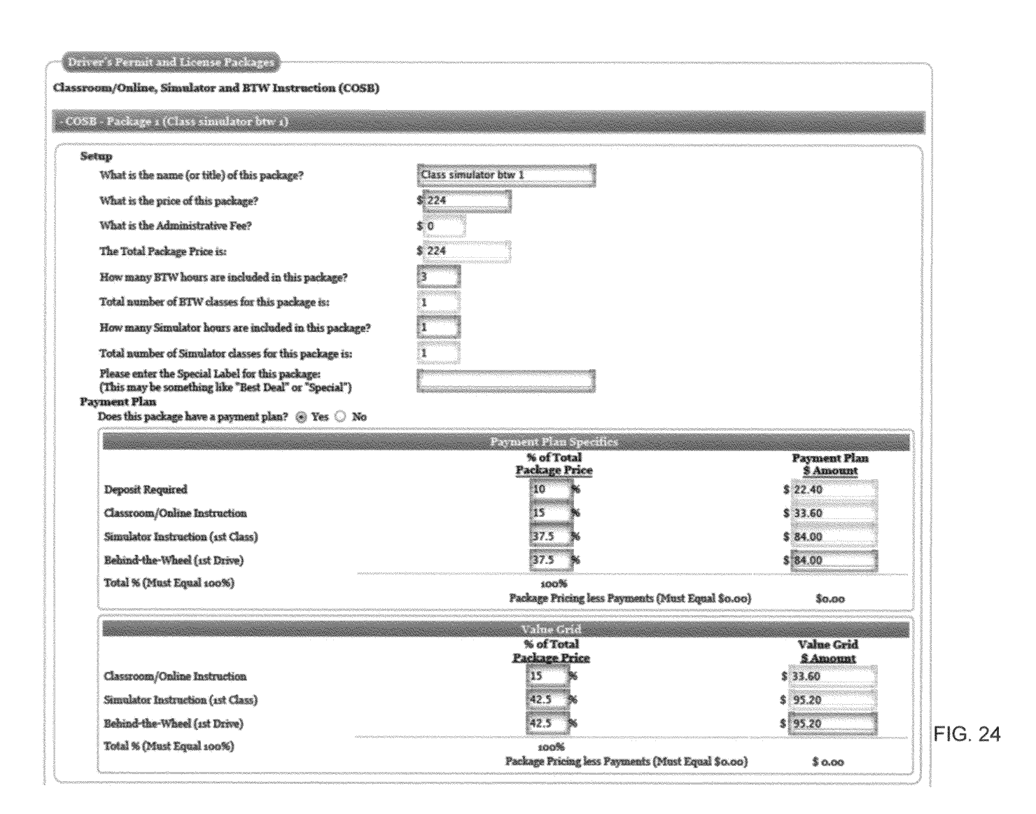

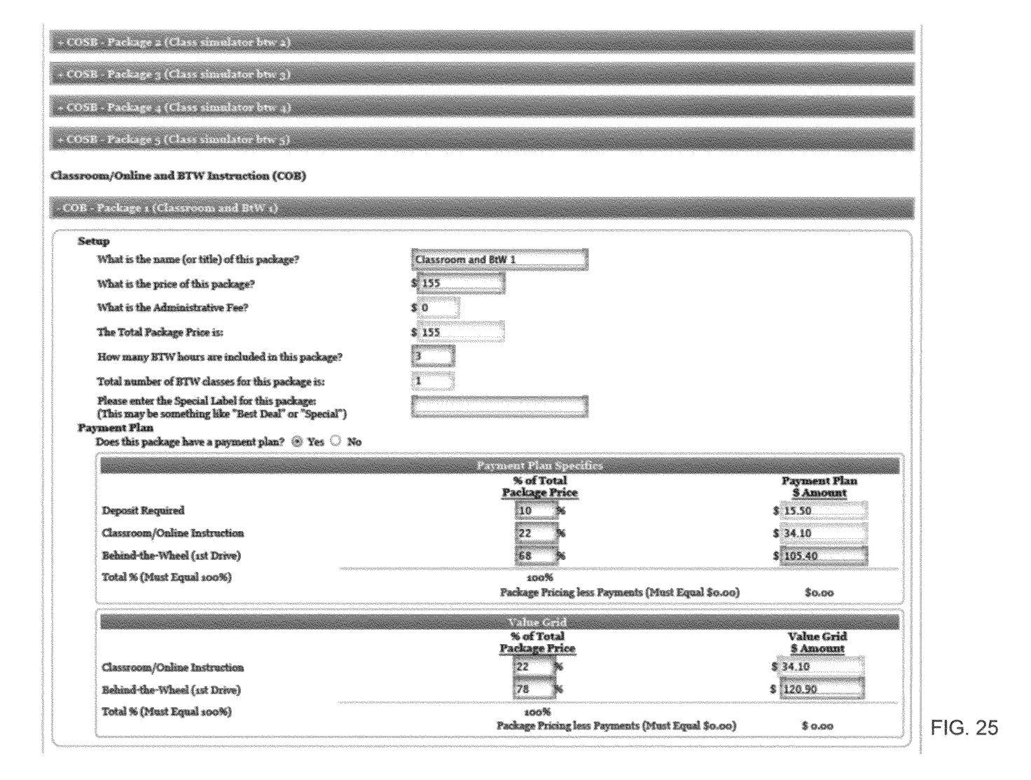

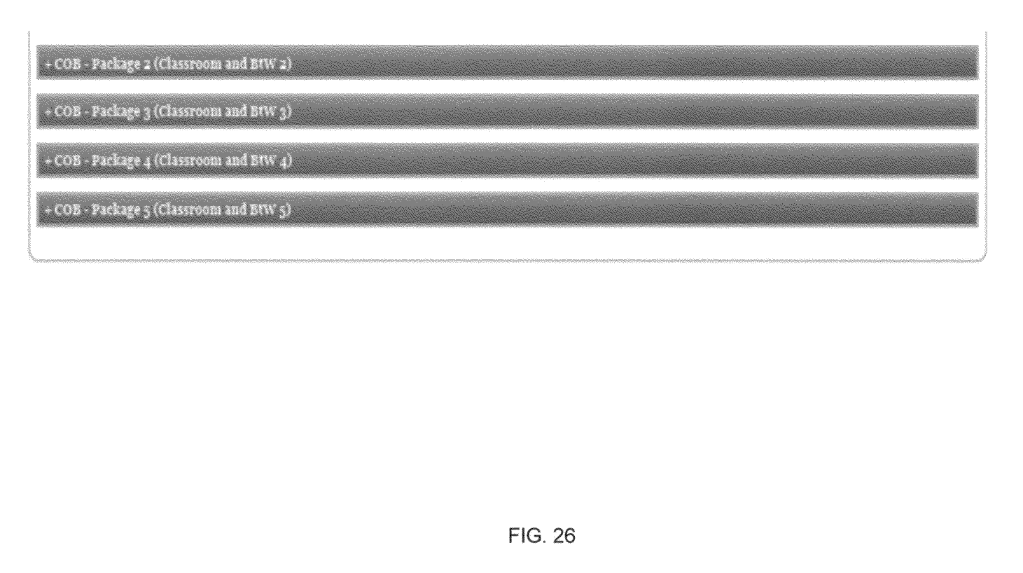

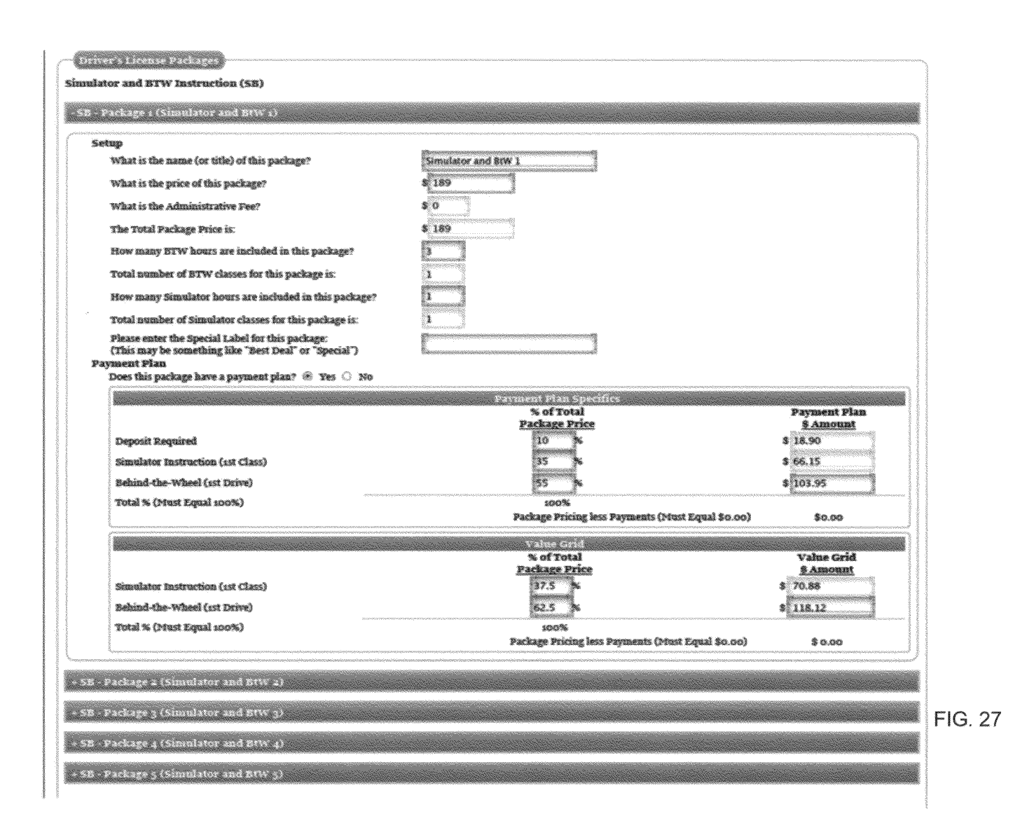

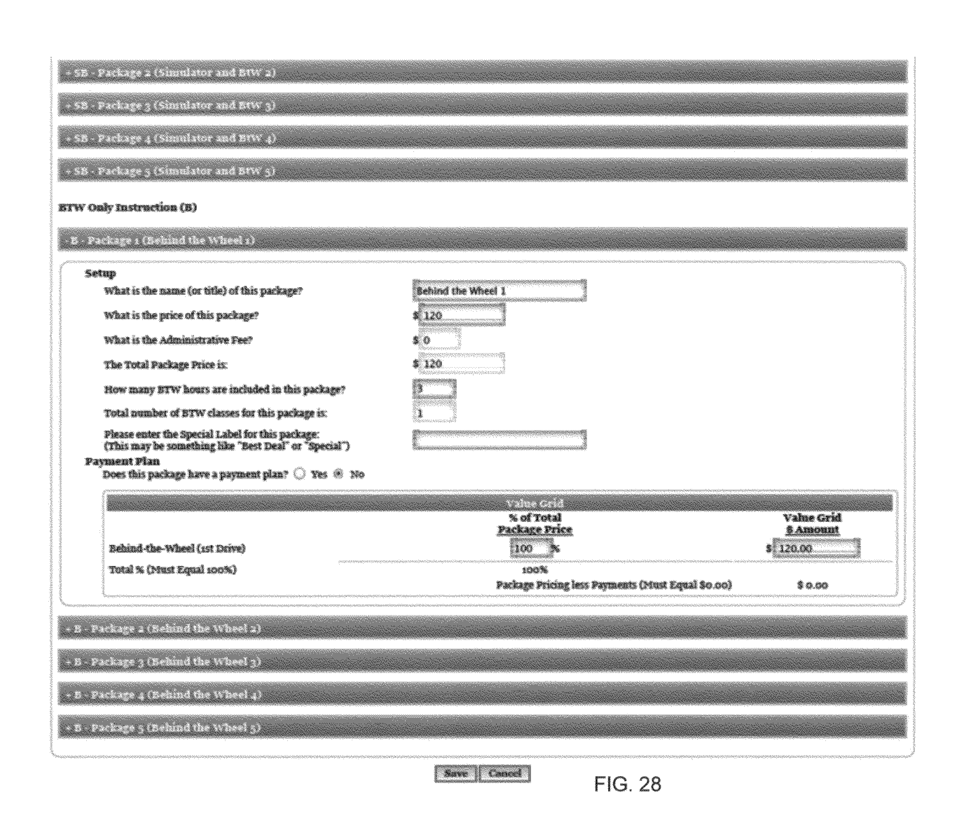

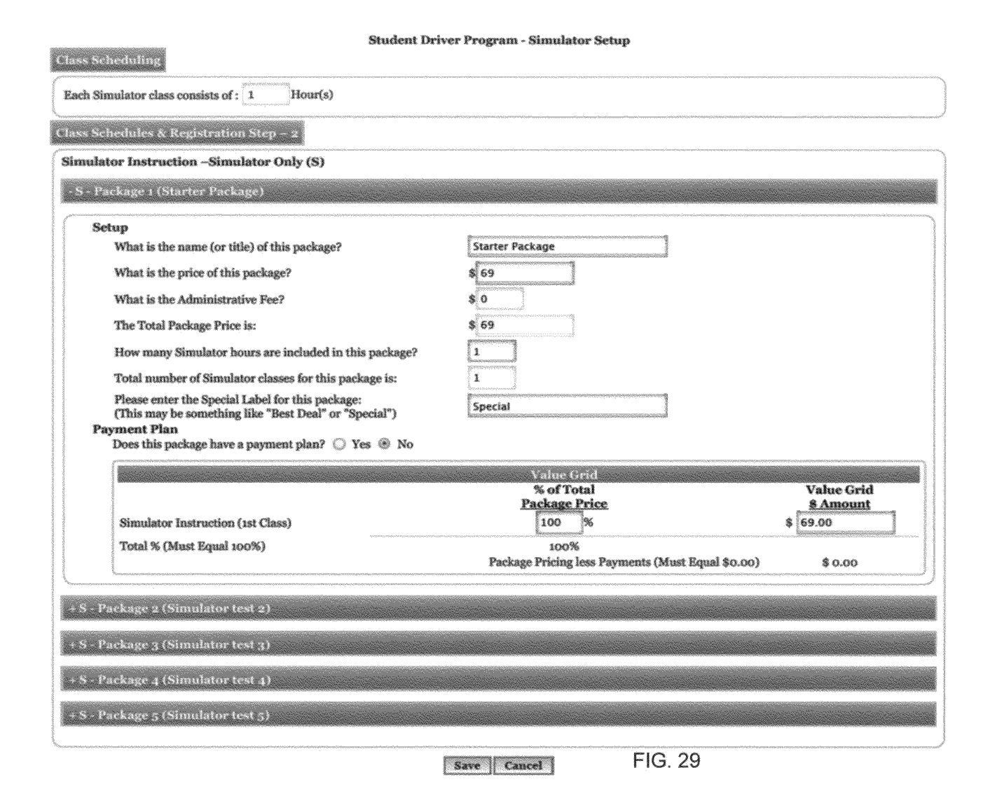

FIGS. 22-29 represent non-limiting examples of screen shots of one possible embodiment for a real-time package creation process.

This process may provide the capability to create “Packages” in the Student Driver Program that enables a traffic school 100, 200 to offer an instructional solution that combines environments (classroom, online, simulator and behind-the-wheel) and hours (for simulator and behind-the-wheel) in a manner that may be more cost effective for the student 310, better fit the student's 310 needs and easier for the student 310 to complete the registration process.

The package creation process (which is performed in the school administration website 140, 240) is integrated with the package presentation process (which is located in the school's public website 130, 230) such that once a package is saved in the package creation process it appears in real-time on the public website 130, 230.

The following automatically appear in the public website 130, 230 once a new package is created: title, price, catch phrase (ex: “Best Value”, “Limited Time” etc. . . . ), classroom or online class notation (as appropriate), number of simulator hours (as appropriate), number of behind-the-wheel hours (as appropriate) and optional payment plan notation (as appropriate).

The real-time package creation process creates and calculates certain aspects of the package such that the traffic school 100, 200 simply needs to answer certain questions and input information into required fields to complete the process.

Upon completion of a registration process by a student 310, the process breaks the package out into the individual classes that make up the package. This allows the traffic school 100, 200 to change the packages at anytime without impacting the information for each student 310 that previously purchased the package.

This process may include a payment plan matrix or a value grid matrix used for pricing out individual components. The package creation process may allow the traffic school 100, 200 to incorporate a payment plan for a package if the traffic school 100, 200 desires to do so.

This process requires the traffic school 100, 200 to assign a dollar value (using a percentage of total price) to each component (class) of the package. This supports the breakout of individual classes, with their associated prices, after the registration process is completed.

This process preferably does not allow an incomplete package to be created or for a package to be completed where the pricing of the individual components (classes) don't correctly add up to the package price.

This process enables a traffic school 100, 200 to offer packages (multiple environments and hours) instead of just individual classes, thereby providing an easier and faster registration process for the student 310.

This process enables the traffic school 100, 200 to breakout packages into the individual class components so that the school 100, 200: may offer the student 310 the ability to reschedule a class at anytime; cancel a class on behalf of the student 310 at any time and know the specific value of the class and either select cash or accrual based accounting as their accounting process. (Without this capability the school's 100, 200 only choice is cash based accounting which typically does not correctly reflect profit and loss information within a certain time period such as a monthly P&L.)

Class Extension Process

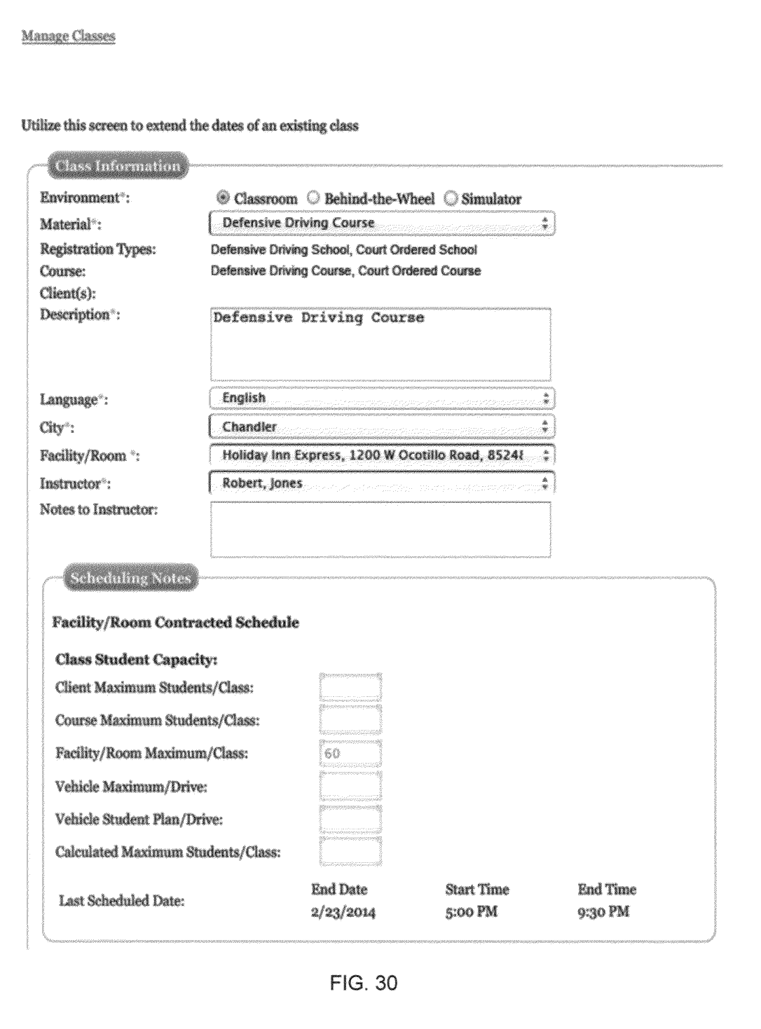

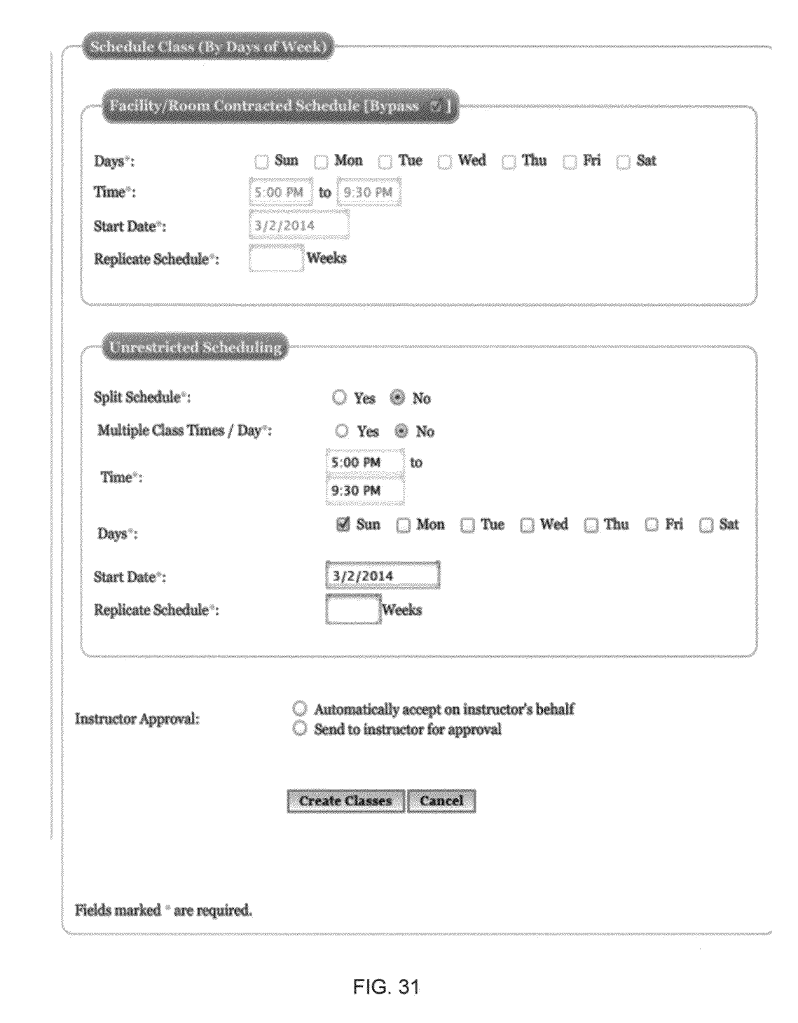

FIGS. 30-31 represent non-limiting examples of screen shots of one possible embodiment for a class extension process.

Traffic schools 100, 200 face a continuous need to add classes as time goes on. Typically this requires the traffic school 100, 200 to create new classes as if they had never previously created a similar class. The class extension process allows the traffic school 100, 200 to select a set of classes that is coming to an end and simply utilize the same information to extend the class out as far as desired.

In the Class Extension Process the application displays the last class (and its pertinent information) of a grouping of classes such that it is extremely easy for a traffic school 100, 200 to identify a class grouping that is approaching its last class.

The Class Extension Process offers a single click option that recalls and prepares the information about a class (grouping) that only requires the following four additional pieces of information (clicks) to create additional classes: additional weeks to extend the class, start date of the additional classes, instructor notification selection and process button.

The Class Extension Process is a major time saving solution for traffic school 100, 200. Depending on the number of cities, locations, instructors and classes that a traffic school 100, 200 has, the monthly time savings can be substantial.

Multifunctional Class Schedules Presentation/Selection

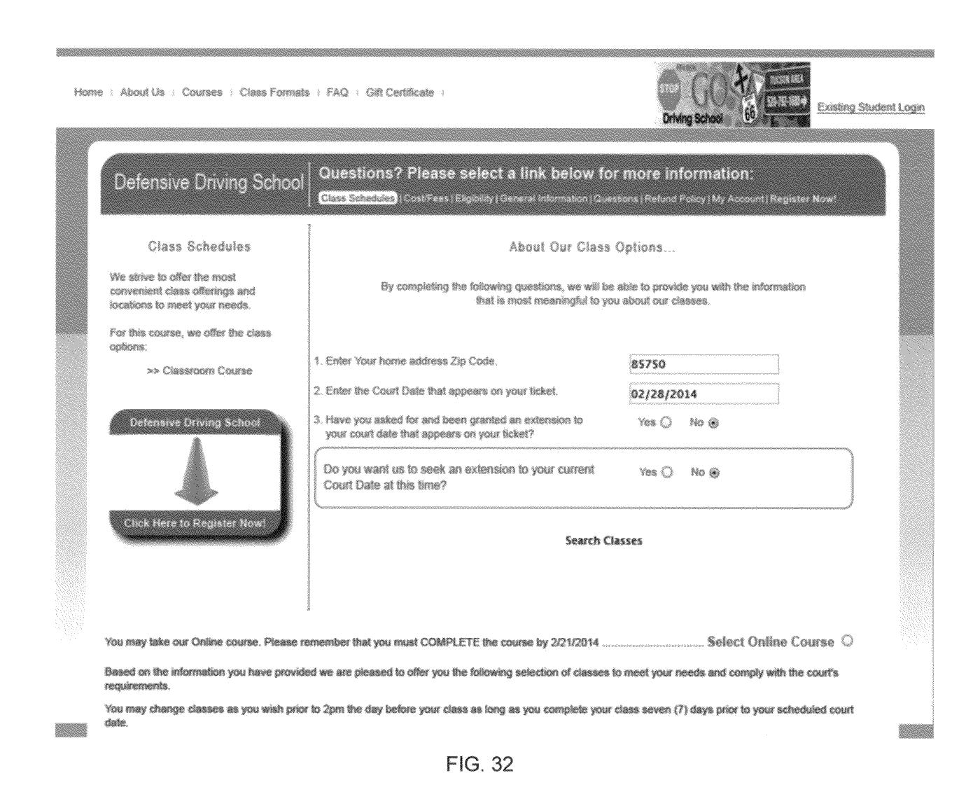

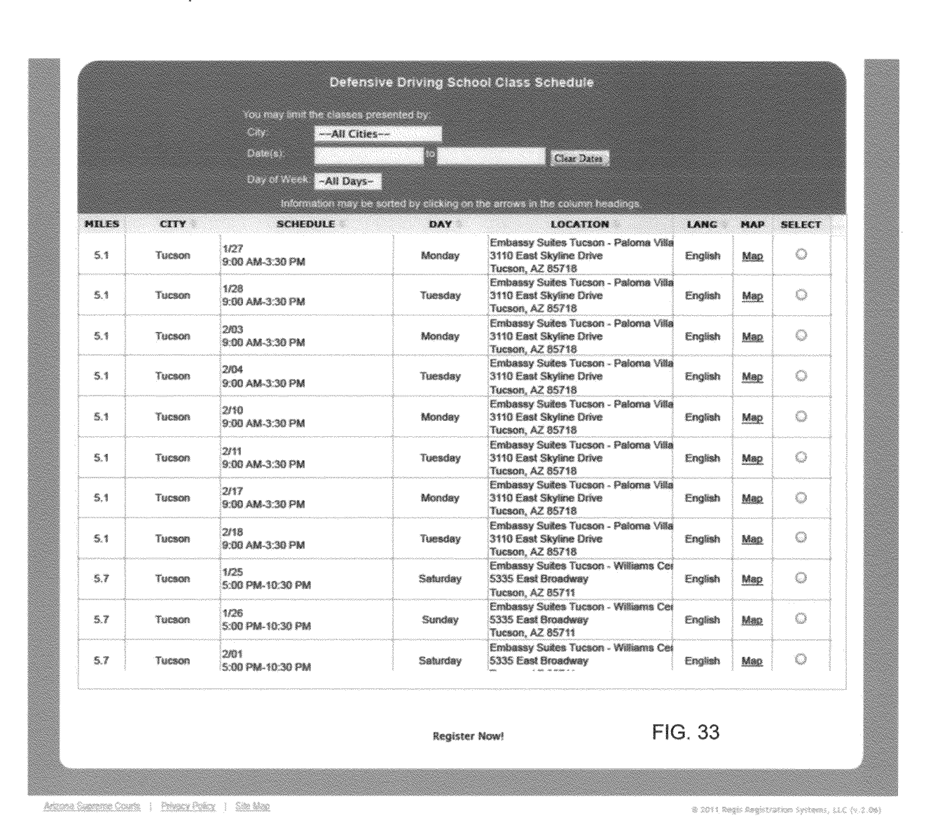

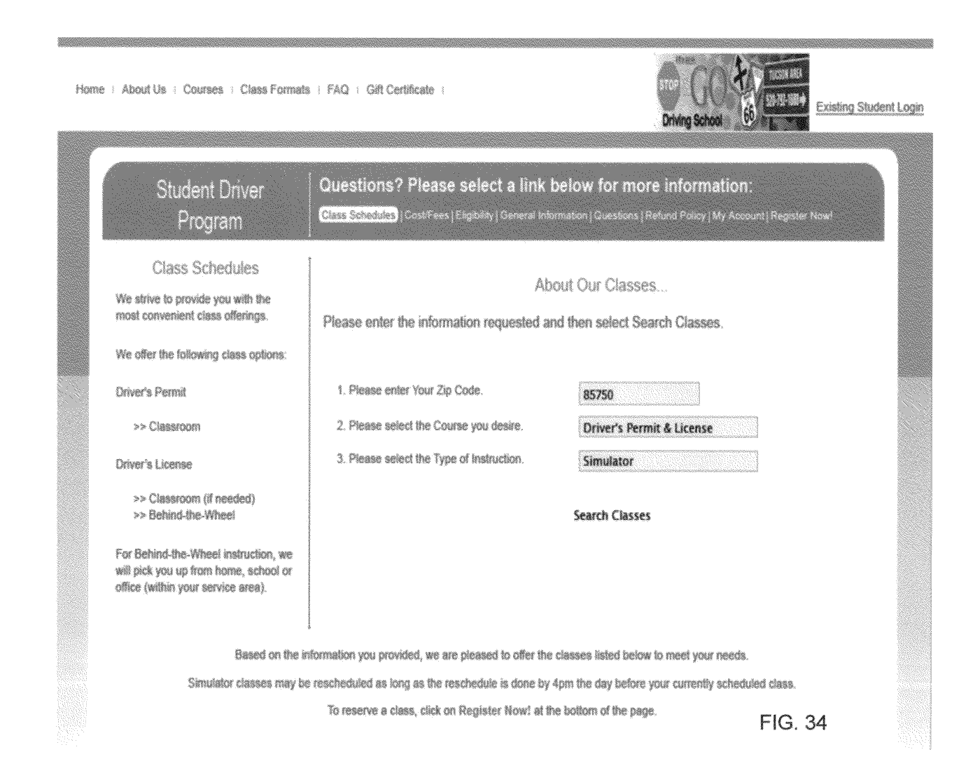

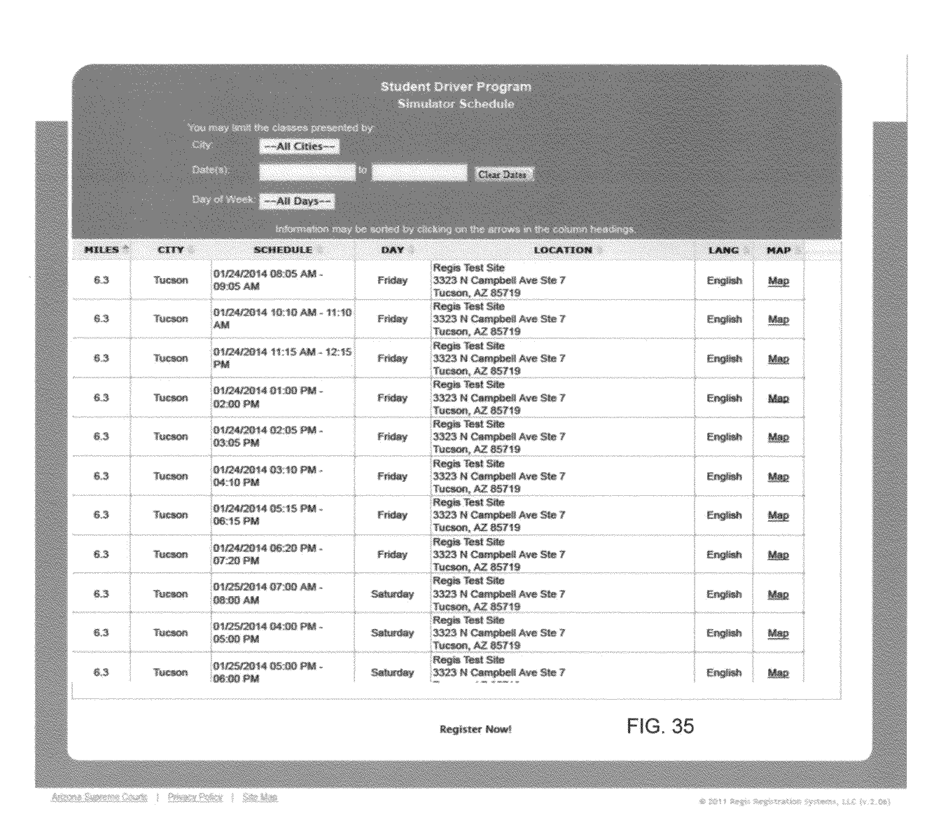

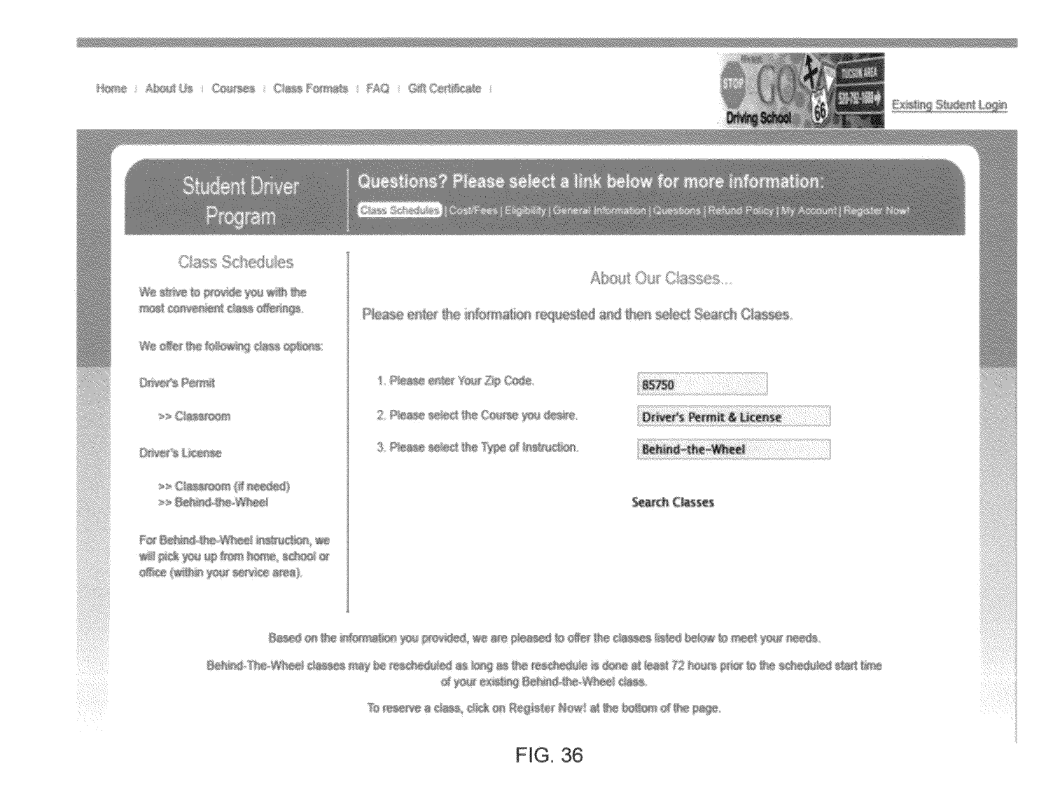

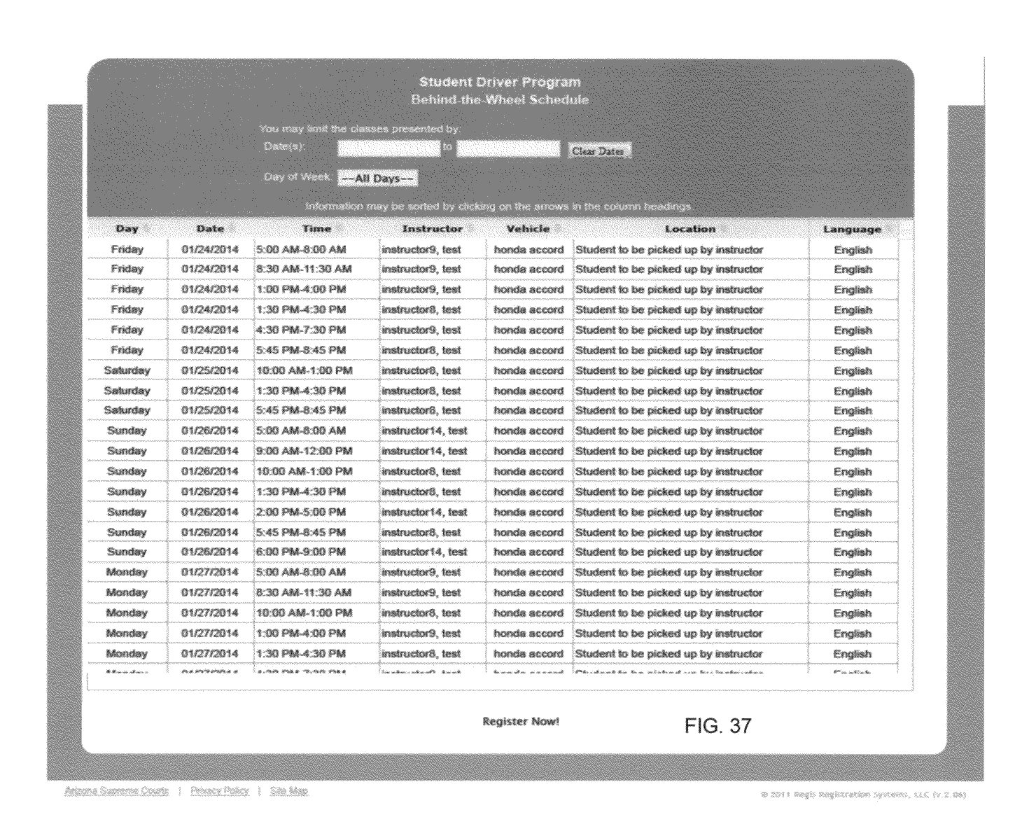

FIGS. 32-37 represent non-limiting examples of screen shots of one possible embodiment for a multifunctional class schedules presentation/selection.

The presentation of classes to the student 310 on the public website 130, 230 is designed to provide the best resource possible for the user (student 310 or traffic school 100, 200) to sort, research and select classes.

The process is designed to meet four requirements:

First, the process preferably only displays those classes that are relevant to the student's 310 need. As an example, in some cases the student 310 must complete a class by a certain date. In these cases the application will not display classes beyond the completion date required.

Second, the process preferably only displays the classes desired by the traffic school 100, 200. In some cases the traffic school 100, 200 would like to create classes well into the future (say 6 months out) but only wants to display the next 60 days (as an example) worth of classes on their public website 130, 230.

Third, the process preferably only displays classes that have available capacity.

And fourth, the process preferably allows the user (student 310 or traffic school 100, 200) to sort the information in a number ways to answer the following questions: What class is closest to their home or work? What class is the next (soonest) available? What classes are being held in a certain city? What classes are being held at a certain location? What classes are being held on a specific day of the week? What classes are being held on a certain date? What classes are being held within a certain set of dates? What classes are being offered in a certain language?

There are many benefits for the multifunctional class schedules presentation/selection function. For classroom and simulator classes all classes may be displayed for the student 310 to view. For behind-the-wheel classes preferably only the most efficient class/drive (instructor) that is available is presented for each class/drive time slot. The student 310 is able to analyze the traffic school's 100, 200 class offerings prior to registering for classes with a traffic school 100, 200. The student 310 may analyze classes in a number of different ways so as to review the data in the format most important and meaningful to them. The student 310 may limit and sort class data in a manner that is best for them. The student 310 may select a class during the analysis process or select a class during the registration process. The student 310 may preferably only select a class during the registration process in the Student Driver Program. The student 310 may view a map image of the class location in question. Upon selection of a class (clicking the radio button in the “Select” column) the function may highlight the entire line of class information in yellow for ease or reading.

Factored Class Creation

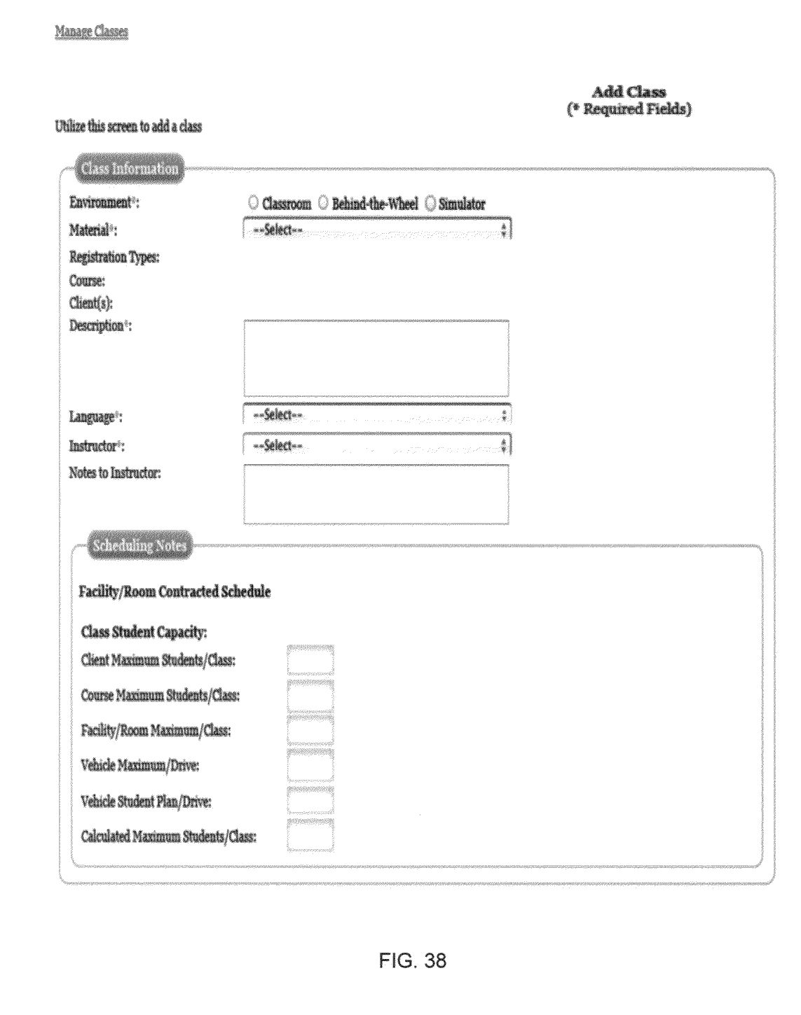

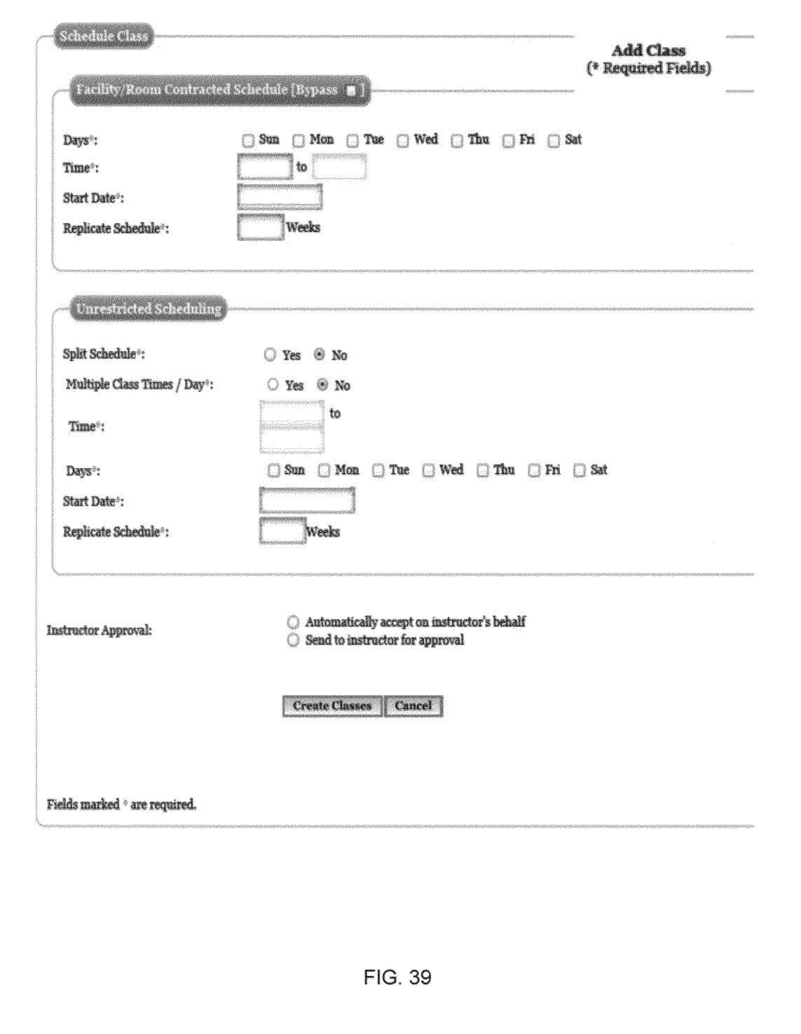

FIGS. 38-39 represent non-limiting examples of screen shots of one possible embodiment for a factored class creation process.

The class creation process may begin with the Class Setup process that establishes the basis for the Create Classes function for the classroom, simulator and behind-the-wheel environments. The setup process may create factors that are considered when creating a class and only allows classes to be built according to the capabilities of the traffic school 100, 200.

The Class Setup process may include: material (curriculum) set up, location set up, vehicle set up, client set up and/or instructor set up. The Class Setup information may become the basis for the Class Creation (Create Class) process.

Additionally, the Create Class process may incorporate the following processes: analysis of contracted meeting rooms, analysis of existing classroom/meeting location utilization, analysis of existing instructor utilization, analysis of existing vehicle utilization (for behind-the-wheel environment only) and analysis of future school holidays scheduled.

The Create Classes function may utilize a “decision tree” process to ensure classes are created properly (i.e. the registration type, environment, course material, city, location or vehicle, location or vehicle availability, qualified instructor, instructor availability and holiday schedule all work together.) The Create Class function may allow the traffic school 100, 200 to determine if the classes should be sent to the instructor for acceptance/approval or if the classes are accepted on behalf of the instructor (by the traffic school 100, 200).

The Create Classes function may guide the traffic school 100, 200 through a list of questions with drop-down selections that are related to previously provided answers so that only classes that the traffic school 100, 200 is capable of executing are created.

Additionally, The Class Creation function may analyze existing utilization of resources to ensure the traffic school 100, 200 does not over utilize any resource.

Change Instructor Process

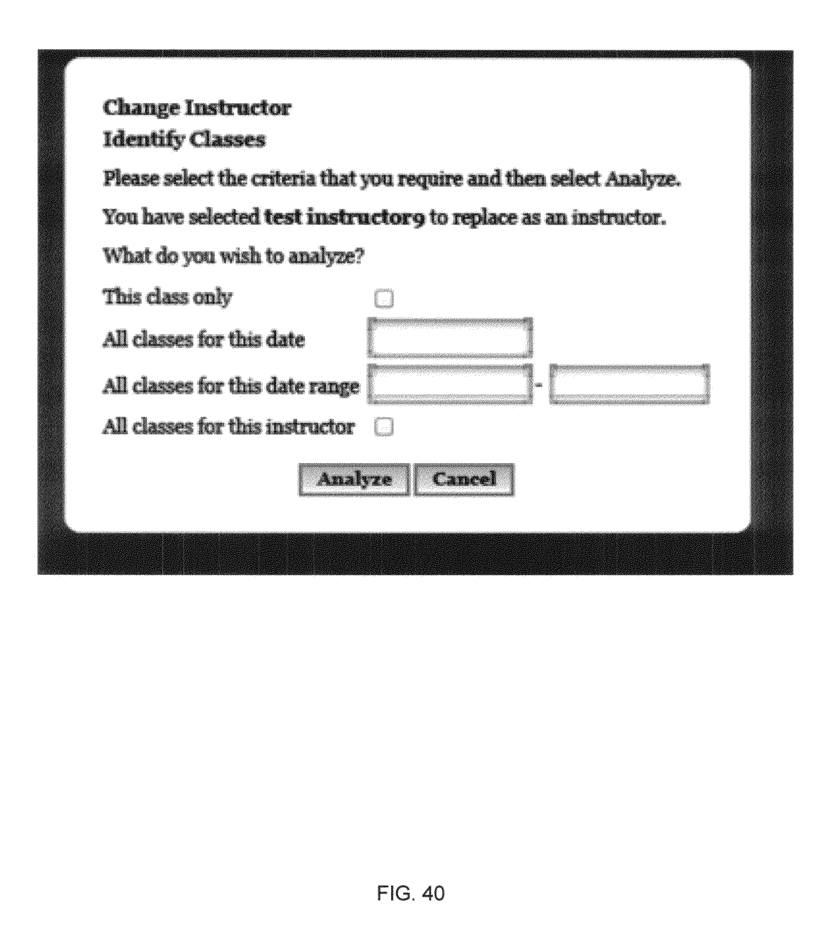

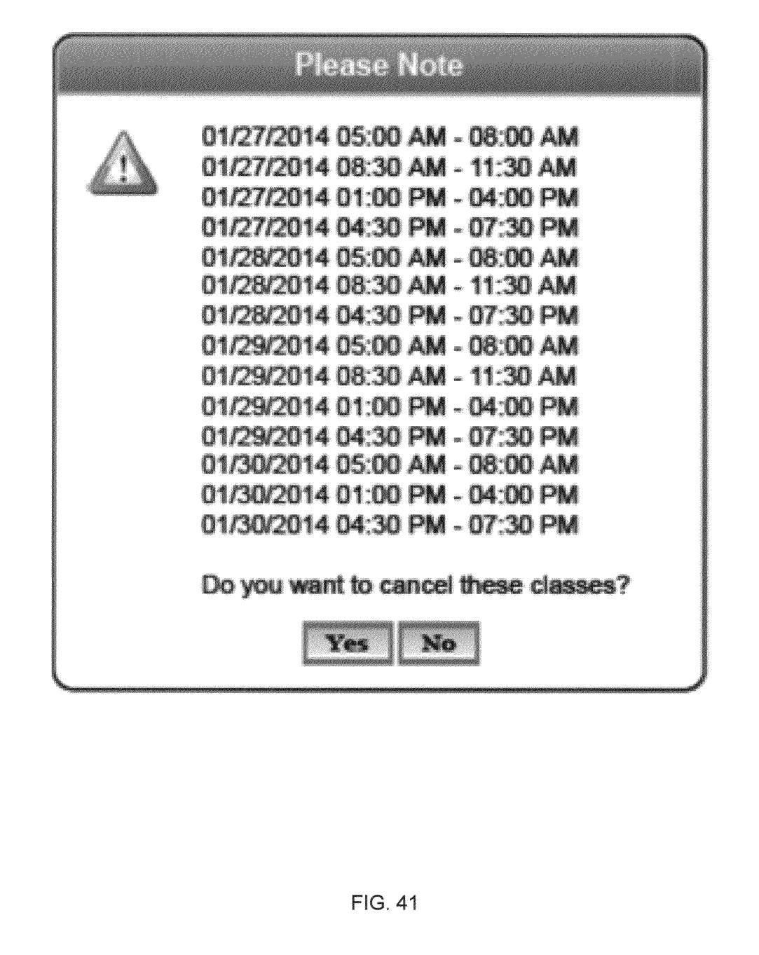

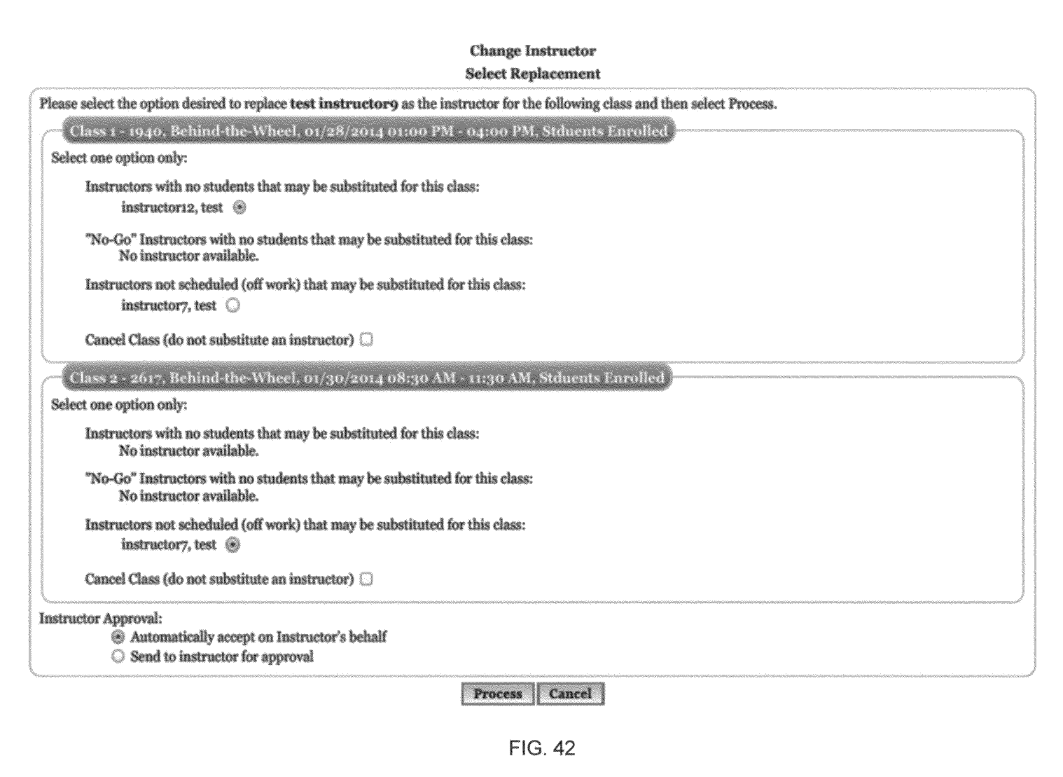

FIGS. 40-42 represent non-limiting examples of screen shots of one possible embodiment for a change instructor process.

This process is designed to be an efficient process for the traffic school 100, 200 to identify a replacement for an instructor to an assigned class or classes when the instructor is unable to conduct the class for any reason.

This simple process allows the traffic school 100, 200 to do the following. First, the traffic school 100, 200 may click the change link (in either the Manage Classes function or the Class Calendar function) for the specific class/instructor in question. The system may allow the traffic school 100, 200 to expand the classes to be analyzed for the specific instructor in the next section.

Second, the traffic school 100, 200 may click the classes to analyze from the following options: this class only (check box), all classes for this date (select date from calendar), all classes for this date range (select beginning and ending dates ranges from calendar) and/or all classes for this instructor (check box).

Third, if a date range of classes or all classes for the instructor is selected, then the traffic school 100, 200 may select from the following additional options to minimize the involvement time of the traffic school 100, 200: select only specific class times for the time period previously selected (or “All”) and select days of the week for the time period previously selected (or “All”).

And Fourth, for each class in question, the traffic school 100, 200 may select the instructor to take over each class or elect to cancel the class. The system may automatically analyze the availability of instructors with the ability (considering qualifications and location) to teach the class and presents the traffic school 100, 200 with all options. If selecting a new instructor (versus canceling a class), the traffic school 100, 200 may specify whether the class should be sent to the instructor for approval or accept the class in behalf of the instructor.

The system may guide the traffic school 100, 200 through all available options to replace an instructor and executes the decision(s) made in real-time. The system may reduce the time required for a traffic school 100, 200 to analyze and determine what instructor to use as a replacement (or simply cancel a class) compared to a manual process.

Change Vehicle Process

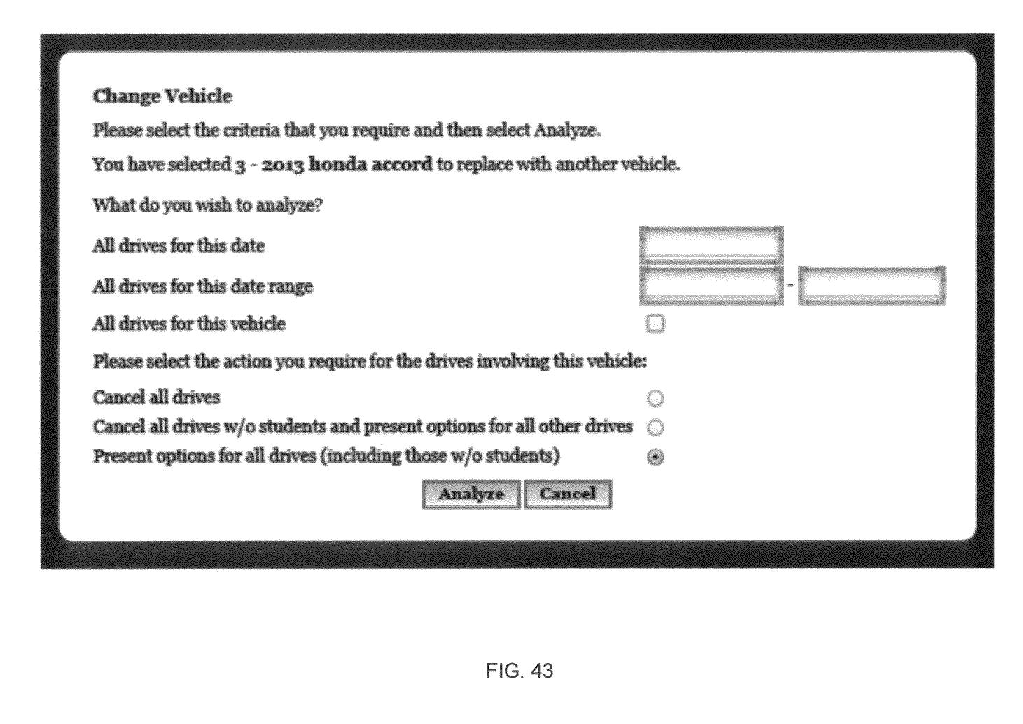

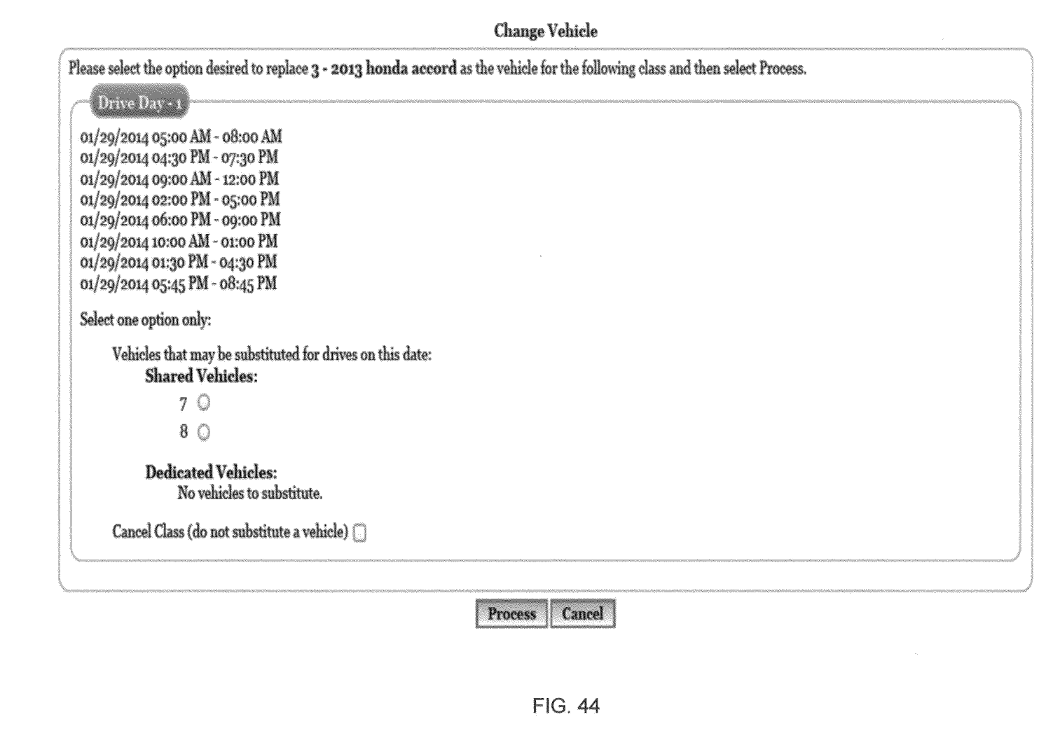

FIGS. 43-44 represent non-limiting examples of screen shots of one possible embodiment for a change vehicle process.

The change vehicle process is an efficient process for the traffic school 100, 200 to identify a replacement for a vehicle scheduled to be used in a behind-the-wheel class (drive). The process may require the traffic school 100, 200 to do the following four actions.

First, the traffic school 100, 200 may click the Change link in either the Vehicle Schedules calendar or the Change Vehicle link in the Class Set Up-Vehicles function for the specific vehicle in question.

Second, the traffic school 100, 200 may select from the following options: all drives for this date (check box), all drives for this date range (select beginning and ending dates ranges from calendar) and all drives for this vehicle (check box).

Third, the traffic school 100, 200 may select from the following options: cancel all drives (check box), cancel all drives w/o students 300 and present instructor options for all other drives or present options for all drives (including those w/o students 300).

And fourth, if the cancel all drives (check box) or cancel all drives w/o students 300 and present instructor option for all other drives were selected, for each day within the time frame selected, the application will present all vehicle replacement options or the option to cancel the drive.

The system may guide the traffic school 100, 200 through all available options to replace a vehicle and executes the decision(s) made real-time. The system reduces the time required for a traffic school 100, 200 to analyze and determine what vehicle to use as a replacement (or simply cancel a class (drive)) compared to a manual process.

Active Class Completion Process

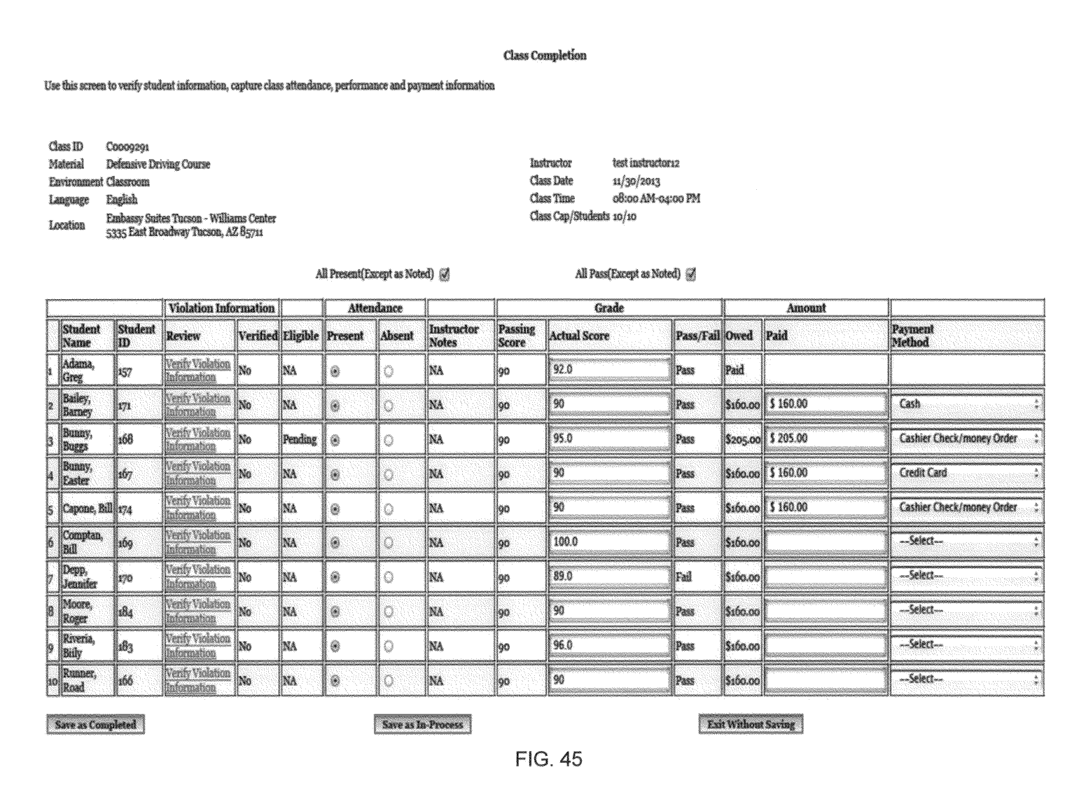

FIG. 45 represents a non-limiting example of a screen shot of one possible embodiment for an active class completion process.

The active class completion process is designed to eliminate errors and to be an efficient process for closing out a student's 310 record. The process may include screen designs that includes real-time violation information review for those students 300 taking Defensive Driving School, Court Ordered School or Traffic Survival School. The process may include a one-click link directly to the student record for the student 310 in question.

The active class completion process may include screen designs that includes eligibility status for those students 300 taking Defensive Driving School.

The active class completion process may include one-click attendance update capability that allows the instructor to show all students 300 as present for the class. The instructor may then click absent for any student 310 that was absent.

The active class completion process may include one-click passing grade update capability that allows the instructor to show all students 300 with passing grades. The instructor may then revise any student's 310 score/grade to identify that they failed the class.

The active class completion process may include the ability for a user to record payments made by each student 310 including the amount of the payment and the payment method which is then used to update the student record for each student 310 with respect to payment and to serve as the basis for managing daily funds reconciliation.

The active class completion process may allow information to be: “Saved as Completed”—which when selected processes all information input, “Saved as In-Process”—which when selected allows the partially completed information to be saved until final data inputs can be entered and the “Save as Completed” process is executed and “Exit Without Saving”—which when selected allows the exit for the screen without changing/saving any information.

The active class completion process may provide critical information associated with Defensive Driving School, Court Ordered School and Traffic Survival School at the time of the class completion process to help ensure accuracy in processing, elimination of mistakes and correctness of information being sent to state agencies.

When the student 310 pays for the class on the day of the class, the active class completion process records the payment information that forms the basis for the daily funds reconciliation.

When the “Save as Completed” button is clicked, the system may perform one more of the following: In the Student Record (school administration website 140, 240) and the My Account page (Public website 130, 230) for the student 310: If a payment has been recorded in the Class Completion screen, the system may reflect the payment in the class information. In other words, the system may show that a payment was made. The system may reflect the test score received by the student 310. The system may reflect the completion date for the class. The system may reflect the certificate of completion number in the class information. The system may add payment information in the Transaction and Notes Record. The system may move the class from the Class Information (Current) section to the Class Information (History) section.

The active class completion process may record all payment information for the class by payment method. This may be used in the daily funds reconciliation process.

The active class completion process may capture all classes that an instructor has taught which becomes the basis for providing pay period information when instructors are paid on a per class basis.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system, comprising:
a) a public website for a traffic school to offer a plurality of classes, operated on one or more hardware servers, configured to allow a plurality of students to register for one or more classes in the plurality of classes; and
b) a school administration website, operated on the one or more hardware servers, accessible by the traffic school and not accessible by the plurality of students, wherein the school administration website is configured to create, modify and cancel one or more classes in the plurality of classes offered on the public website in real time.

2. The system of claim 1, further comprising:
c) a master website, operated from the one or more hardware servers, configured to set up the traffic school, wherein the traffic school comprises the public website and the school administration website.

3. The system of claim 1, wherein the public website and the school administration website are dedicated only to the traffic school.

4. The system of claim 2, wherein the master website is configured to set up a plurality of traffic schools.

5. The system of claim 2, wherein the traffic school offers one or more classes in a defensive driving school, a court ordered school, a traffic survival school, a student driver program, an insurance discount program, a corporate program or a municipality program.

6. The system of claim 1, wherein the public website lists one, and only one, most efficient and available instructor for each of a plurality of start time slots for a behind-the-wheel driving class to a student accessing the public website, where the most efficient instructor is determined based on a zip code of the student and a service area, a priority and an availability of the instructor in relation to a service area, a priority and an availability of the plurality of instructors.

7. The system of claim 1, wherein the school administration website is configured to create a plurality of classes in a plurality of environments and verify that the plurality of classes are valid.

8. The system of claim 1, wherein the school administration website is configured for the traffic school to change an instructor for a class in the plurality of classes.

9. The system of claim 1, wherein the school administration website is configured for the traffic school to change a vehicle with respect to a class in the plurality of classes.

10. The system of claim 1, wherein the school administration website is configured for the traffic school to break up a created class package into one or more classes, in the plurality of classes, within a student record.

11. The system of claim 1, wherein the student is automatically notified by text message, email and/or phone call, based on a preference expressed by the student.

12. The system of claim 1, wherein the school administration website is configured for the traffic school to close out a class once it has been taught and record a student information in a student record.

13. A method, comprising the steps of:
a) a master website creating a school administration website:
i) wherein the school administration website and a public website are dedicated to a traffic school,
ii) wherein the school administration website is accessible to the traffic school and not to a plurality of students,
iii) wherein the school administration website is configured for the traffic school to modify a pricing for a class on the public website, and
iv) wherein the public website and the school administration website are operated from one or more hardware servers; and
b) the administration website modifying the public website, wherein the public website is accessible over a network by a student in the plurality of students.

14. The method of claim 13, further comprising the step of:
c) the master website creating a plurality of school administration websites for a plurality of traffic schools,
i) wherein each school administration website in the plurality of school administration websites are dedicated to one, and only one, traffic school, in the plurality of traffic schools.

15. The method of claim 13, further comprising the step of:
c) the public website displaying one, and only one, instructor in a plurality of instructors, for a student driving program,
i) wherein the instructor is available and the instructor is the most efficient instructor in the plurality of instructors, and
ii) wherein the most efficient instructor is determined using a zip code associated with a student accessing the public website and a plurality of zip codes associated with the plurality of instructors.

16. The method of claim 13, further comprising the step of:
c) the public website displaying an active calendar, wherein the active calendar comprises business information with integrated business management functionality.

17. The method of claim 13, wherein the school administration website is configured, based on input from the traffic school, to combine a plurality of classes into a package offering a single price and have the package and the single price appear in real-time on the public website.

18. The method of claim 13, wherein the school administration website is configured, based on input form the traffic school, to extend a class that is expiring.

19. The method of claim 13, further comprising the step of:
c) extending a court date for the student in the plurality of students.

20. The method of claim 13, further comprising the steps of:
c) limiting a plurality of classes offered by the traffic school based on either a city, a date range or a day of the week; and
d) sorting the limited plurality of classes using a location of the student.

21. A method, comprising the steps of:
a) one or more hardware servers receiving a geographical location from a traffic school, wherein the traffic school offers a student driver program in the geographical location;
b) breaking the geographical location into a plurality of matrix zones using the one or more hardware servers;
assigning each instructor in a plurality of instructors to a matrix zone in the plurality of matrix zones using the one or more hardware servers;
d) determining, on the one or more hardware servers, a matrix zone for a student accessing a public website;
the one or more hardware servers determining for each start time slot in a plurality of start time slots on the public website one, and only one, instructor that is available and most efficient, wherein the most efficient instructor for each start time slot is determined based on a matrix zone assigned to the instructor and the matrix zone determined for the student; and
f) the one or more hardware servers displaying the one, and only one, instructor for each start time slot in a plurality of start time slots to the student on the public website to select for a behind-the-wheel driving class.
